(19) United States
(12) Patent Application Publication
(10) Pub. No.: US 2024/0425630 A1
(43) Pub. Date: Dec. 26, 2024

(54) POLYMER DISPERSION COMPOSITION

(71) Applicants: Dow Global Technologies LLC, Midland, MI (US); Rohm and Haas Company, Collegeville, PA (US)

(72) Inventors: Joseph B. Binder, Haverford, PA (US); Isabelle Uhl, Grasse (FR); Steve Pham, Doylestown, PA (US); Vesna Daniloska, Tarragona (ES)

(21) Appl. No.: 18/700,855

(22) PCT Filed: Nov. 22, 2022
(86) PCT No.: PCT/US2022/080317

§ 371 Date: Apr. 12, 2024

Related U.S. Application Data
(60) Provisional application No. 63/290,299, filed on Dec. 16, 2021.

(51) Int. Cl. C08F 220/18; C08F 2/26; C08K 5/25; C09J 5/04; C09J 133/24

(52) U.S. Cl. CPC C08F 220/1804; C08F 2/26; C08F 220/1808; C08K 5/25; C09J 133/24; C09J 5/04

(57) ABSTRACT

A waterborne precursor polymer dispersion composition comprising the reaction product obtained by free-radical emulsion polymerization of a monomer mixture comprising: (A) at least one alkyl (meth)acrylate; and (B) at least one ethylenically unsaturated compound comprising: (Bi) at least one first functional group; wherein the at least one first functional group comprises at least one ethylenically unsaturated group; and (Bii) at least one second functional group; wherein the at least one second functional group comprises at least one functional group different than the ethylenically unsaturated group; wherein the second functional group is capable of reacting with a crosslinker component; and wherein the crosslinker component is not reactive with component (A) in free-radical polymerization; in the presence of: (C) an aqueous medium; and (D) at least one acid surfactant salt with pKaH from 2.6 to 7; a waterborne contact adhesive polymer dispersion composition including a mixture of: (I) the above waterborne precursor polymer dispersion composition and (II) a crosslinker compound for crosslinking with the at least one second functional group, component (Bii); a bonded article including at least two substrates adhered together with the above waterborne contact adhesive polymer dispersion composition; a process for preparing the above waterborne precursor polymer dispersion composition; a process for preparing the above waterborne contact adhesive composition; and a process of bonding two substrates together using the above waterborne contact adhesive composition to form a bonded article.

### FIELD

The present invention relates to polymer dispersion compositions; and more specifically, the present invention relates to poly(chloroprene)-free, waterborne polymer dispersion compositions which can be used for producing poly(chloroprene)-free, waterborne contact adhesive compositions that, in addition to being free of poly(chloroprene), are fast-setting.

### BACKGROUND

The term “contact adhesive” refers to an adhesive which is typically applied to the surface of one of two workpieces or substrates that are to be adhered (bonded) together. To bond the two substrates together, the surface of one substrate containing the adhesive is brought into contact with the surface of the other substrate such that the adhesive is positioned between the two substrates; and then pressure is applied to the two substrates. The contact adhesive forms a fast-acting, if not an immediate, durable bond in between the two substrates pressed together. Once the contact adhesive-coated surfaces have been pressed together, the adhered pieces are ready for further processing. For example, a “fast-setting” contact adhesive enables adhered substrates to be handled within 20 seconds (s) to 5 minutes (min) after application of the adhesive to the substrates. Such “fast-setting” adhesives display instant tack by resisting debonding within 20 s to 5 min after application, even at ambient temperature. Contact adhesives are formulated so that no adhesive curing is required to achieve the desired adhesion.

Most contact adhesives, in particular fast-setting contact adhesives, are one-component adhesives based on poly(chloroprene). Waterborne based contact adhesives, including waterborne contact adhesives based on poly(chloroprene) dispersions, are preferred for environmental reasons. Such dispersions containing poly(chloroprene) are typically only stable at basic pH (pH 8 or above) and coagulate under pH 8. Chloroprene is volatile, flammable, halogenated, and hazardous. Polymers based on chloroprene may cause allergic reactions. Accordingly, waterborne contact adhesives which do not contain (poly)chloroprene are more desirable for environmental and health reasons. However, it is well known that it is difficult to formulate waterborne contact adhesives that: (1) are fast-setting (e.g., contact adhesives that set within five minutes); (2) rapidly form bonds strong enough to resist failure of the adhesive bond before the bonded substrate (e.g., foam) tears (e.g., within 60 min); and (3) do not contain poly(chloroprene).

WO2020057999 discloses a polymer latex composition made from monomers comprising at least one alkyl (meth)acrylate (e.g., butyl acrylate [BA]), at least one ethylenically unsaturated compound comprising at least one additional functional group (e.g., diacetone acrylamide [DAAM]), in the presence of a surfactant system comprising anionic surfactants including an alkyl carboxylic acid salt (e.g., oleate). The monomer mixture of the above reference does not comprise any ethylenically unsaturated acids such as acrylic acid (AA), methacrylic acid (MAA), and the like. In addition, the composition disclosed in the above reference further comprises a compound which is not polymerizable by free-radical polymerization which comprises at least 2 functional groups capable of reacting with the at least one additional functional group (e.g., adipic dihydrazide [ADH]). The compound capable of reacting with the at least one additional functional group (e.g., ADH) acts as a crosslinker in reaction with the at least one functional group in the polymer (e.g., DAAM ketone functional group) to crosslink the polymer to provide bonding strength. The polymerization of the composition disclosed in the above reference is carried out at a pH of 7.5 or higher. The resultant composition taught in the above reference during polymerization coagulates at a pH of less than 7.5 such that the resultant composition cannot be applied to a substrate at less than a pH of 7.5. Application of the polymer latex composition at pH 7.5 or greater is disadvantageous because the pH optimum for the hydrazone-forming crosslinking reaction of ADH and DAAM is approximately pH 4.5 and the reaction rate of this reaction is slow at neutral pH (Kolmel, D. K.; Kool, E. T. Chem. Rev. 2017, 117, 10358-10376). Kinetic data for this type of reaction between a nucleophile and a carbonyl compound shows that the rate of reaction increases rapidly as the pH decreases below pH 7.5 (Cordes, E. H.; Jencks, W. P. J. Am. Chem. Soc. 1962, 84, 4319).

It is therefore desirous to provide waterborne polymer dispersions which are free of poly(chloroprene) and that can be further processed to form fast-setting contact adhesives; and particularly it is desirous to provide a waterborne polymer dispersion composition that can be processed at a pH of less than 7.5.

### SUMMARY

One embodiment of the present invention is directed to a crosslinkable waterborne precursor polymer dispersion (PPD) composition comprising the reaction product obtained by free-radical emulsion polymerization of a monomer mixture comprising:
(A) at least one alkyl (meth)acrylate; and
(B) at least one ethylenically unsaturated compound comprising:
   (Bi) at least one first functional group; wherein the at least one first functional group comprises at least one ethylenically unsaturated group; and
   (Bii) at least one second functional group; wherein the at least one second functional group comprises at least one functional group different than the ethylenically unsaturated group; wherein the second functional group is capable of reacting with a crosslinker component; and wherein the crosslinker component is not reactive with component (A) in free-radical polymerization; in the presence of:
(C) an aqueous medium; and
(D) at least one acid surfactant salt with pKaH from 2.6 to 7; wherein the molecule of the acid surfactant salt contains 10 or more carbon atoms.

Another embodiment of the present invention is directed to a waterborne contact adhesive polymer dispersion (CAPD) composition free of poly(chloroprene) including: (I) the above-described crosslinkable waterborne PPD composition obtained by free-radical emulsion polymerization of a monomer mixture; and (II) a crosslinker compound (e.g., a bifunctional crosslinking agent) for crosslinking with the at least one second functional group, component (Bii); wherein the waterborne CAPD composition is (1) poly(chloroprene)-free and (2) fast-setting.

Other embodiments of the present invention include a process for preparing the above-described crosslinkable waterborne PPD composition; a process for preparing the above-described waterborne CAPD composition; a bonded article comprising at least two substrates (workpieces) adhered together with the above waterborne CAPD composition; and a process of bonding (adhering) at least two substrates together using the above waterborne CAPD composition to form a bonded article.

Still other embodiments of the present invention include a process of bonding two substrates together using the above-described waterborne CAPD composition to form a bonded article; and a bonded article including at least two substrates adhered together with the above-described waterborne CAPD composition.

An objective of the present invention is to provide a waterborne CAPD composition having one or more advantageous/beneficial properties. For example, the waterborne CAPD composition of the present invention can: (1) be used in an aqueous medium; (2) be formulated and used at a pH of less than 7.5; (3) have a high bond strength (e.g., an adhesive strength sufficient to pass a conventional adhesion test); (4) set within a fast period of time (e.g., a time of less than 5 minutes); (5) within 60 min, form bonds strong enough to resist failure of the adhesive bond before the bonded substrate (e.g., a conventional polyurethane foam) tears; and (6) can be applied by spraying.

### DETAILED DESCRIPTION

Temperatures herein are in degrees Celsius (° C.).

“Room temperature (RT)” and “ambient temperature” herein means a temperature between 20° C. and 26° C., unless specified otherwise.

“pKa” is the negative logarithm of the acid dissociation constant (Ka) of a Brønsted acid at ambient temperature.

A “conjugate acid” is the protonated form of a base. For example, in the following equation:

A⁻+BH↔AH+B⁻

“AH” is the conjugate acid of the base “A-”. In another example, oleic acid (AH) is the conjugate acid of the oleate anion (A⁻).

“pKaH” is the pKa of the conjugate acid of a base. In the case of an anionic surfactant, the pKaH is the pKa of the conjugate acid of the basic anionic part of the surfactant. For example, the pKaH of ammonium oleate is the pKa of the conjugate acid of the oleate anion, which is oleic acid.

“Tg” is the polymer glass transition temperature.

As used herein, the term “poly(chloroprene)-free” and the phrase “free of poly(chloroprene”, with reference to a contact adhesive polymer dispersion composition, herein means that the contact adhesive polymer dispersion composition contains no amount of poly(chloroprene) or contains only a small or minute amount (or a contamination quantity) of poly(chloroprene) in the range of from 0 to less than 500 ppm.

The term “fast-setting”, with reference to a contact adhesive polymer dispersion composition, herein means that the contact adhesive polymer dispersion composition sets within a fast period of time of less than 5 min by displaying resistance to debonding when pulled apart with a fingertip force.

The term “dry weight” herein means the residual weight after a sample has been dried according to the method described in the Examples to measure dispersion solids.

The term “polymodal particle size distribution,” as used herein, is a plurality of particles having a distribution of particle sizes discriminated according to mass fractions characterized by a polydispersity index (or “PDi”)=(d₉₀−d₁₀)/d₅₀; wherein d₁₀ is the particle diameter below which 10% by weight of the polymer particles fall, d₅₀ is the particle diameter below which 50% by weight of the polymer particles fall, and d₉₀ is the particle diameter below which 90% by weight of the polymer particles fall.

A polymodal particle size distribution differs from a monomodal particle size distribution (i.e., a single distribution, or a Gaussian distribution); a polymodal particle size distribution possessing at least two pronounced maxima, which differ by at least 50 nm, or differ by at least 100 nm.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa.

The numerical ranges disclosed herein include all values from, and including, the lower and upper value. For ranges containing explicit values (e.g., a range from 1, or 2, or 3 to 5, or 6, or 7), any subrange between any two explicit values is included (e.g., the range 1 to 7 above includes subranges 1 to 2; 2 to 6; 5 to 7; 3 to 7; 5 to 6; and the like.).

As used throughout this specification, the abbreviations given below have the following meanings, unless the context clearly indicates otherwise: “=” means “equal(s)” or “equal to”; “<” means “less than”; “>” means “greater than”; “≤” means “less than or equal to”; ≥” means “greater than or equal to”; “@” means “at”; g=gram(s); Da=Daltons; L=liter(s); M=mole(s) per liter; ppm=parts per million by weight; RPM=revolutions per minute; m=meter(s); mm=millimeter(s); cm=centimeter(s); nm=nanometer(s); min=minute(s); s=second(s); ms=millisecond(s); hr=hour(s); Pa=pascals; kPa=kilopascals; mPa-s=millipascal second(s); g/mol=gram(s) per mole(s); Mₙ=number average molecular weight; M_{w}=weight average molecular weight; 1/s or sec⁻¹=reciprocal second(s) [s⁻¹]; %=percent; vol %=volume percent; mol %=mole percent; and wt %=weight percent.

Unless stated otherwise, all percentages, parts, ratios, and the like amounts, are defined by weight. For example, all percentages stated herein are weight percentages (wt %), unless otherwise indicated.

Specific embodiments of the present invention are described herein below. These embodiments are provided so that this disclosure is thorough and complete; and fully conveys the scope of the subject matter of the present invention to those skilled in the art.

The waterborne, PPD composition, which can be used to produce a waterborne (aqueous or water-based), CAPD composition of the present invention, includes a waterborne PPD composition that is crosslinkable with a crosslinking compound, crosslinking composition, or crosslinking agent (“crosslinker”). After the crosslinkable waterborne PPD composition is prepared by emulsion polymerization, the crosslinkable waterborne PPD composition is blended with a crosslinker compound or composition to form the waterborne CAPD composition prior to applying the resultant waterborne CAPD composition to a substrate that is to be bonded with one or more other substrates.

In a broad embodiment, the crosslinkable waterborne PPD composition of the present invention generally includes a polymer dispersion obtained by emulsion polymerization of a mixture of monomers in the presence of water and an acid surfactant salt (or emulsifier). In one preferred embodiment, the present invention includes a crosslinkable waterborne PPD composition, wherein the PPD composition comprises the reaction product obtained by free-radical emulsion polymerization of a monomer mixture. In another preferred embodiment, the monomer mixture of the PPD composition comprises: (A) at least one alkyl (meth)acrylate; and (B) at least one ethylenically unsaturated compound having at least two functional groups, wherein the functional groups comprise: (Bi) at least one first functional group; wherein the at least one first functional group comprises at least one ethylenically unsaturated group; and (Bii) at least one second functional group; wherein the at least one second functional group comprises at least one functional group different than the ethylenically unsaturated group; wherein the second functional group is capable of reacting with a crosslinker component; and wherein the crosslinker component is not reactive with component (A) in free-radical polymerization. In still another preferred embodiment, the emulsion polymerization of the monomer mixture is carried out in (C) an aqueous medium (e.g., water); and in the presence of (D) at least one acid surfactant salt having a pKaH from 2.6 to 7; wherein the molecule of the acid surfactant salt contains 10 or more carbon atoms.

The at least one alkyl (meth)acrylate, component (A), useful in forming the waterborne PPD composition, can be methyl (meth)acrylate; ethyl (meth)acrylate; propyl (meth)acrylate; n-butyl (meth)acrylate; isobutyl (meth)acrylate; s-butyl (meth)acrylate; t-butyl (meth)acrylate; pentyl (meth)acrylate; hexyl (meth)acrylate; cyclohexyl (meth)acrylate; 2-ethylhexyl (meth)acrylate; heptyl (meth)acrylate; 2-propylheptyl (meth)acrylate; n-octyl (meth)acrylate; iso-octyl (meth)acrylate; nonyl (meth)acrylate; decyl (meth)acrylate; iso-decyl (meth)acrylate; undecyl (meth)acrylate; dodecyl (meth)acrylate; tridecyl (meth)acrylate; heptadecyl (meth)acrylate; lauryl (meth)acrylate; stearyl (meth)acrylate; norbornyl (meth)acrylate; iso-bornyl (meth)acrylate; 4-t-butylcyclohexyl (meth)acrylate; 3,3,5-trimethylcyclohexyl (meth)acrylate; and mixtures thereof. In one preferred embodiment, the alkyl (meth)acrylate, component (A), used in the present invention is n-butyl acrylate, 2-ethylhexyl acrylate, methyl methacrylate, and mixtures thereof.

The concentration of the alkyl (meth)acrylate used in the waterborne PPD composition is from 55 weight percent (wt %) to 99.75 wt % in one general embodiment; from 80 wt % to 99.5 wt % in another embodiment; and from 90 wt % to 99 wt % in still another embodiment based on the weight percentage of the total monomer units comprising the polymer.

The at least one ethylenically unsaturated compound, component (B), useful in forming the waterborne PPD composition includes at least one compound having two different functional groups. For example, the different functional groups include (Bi) at least one first functional group; and (Bii) at least one second functional group different than the first functional group (Bi). In one preferred embodiment, the at least one first functional group, (Bi), comprises at least one ethylenically unsaturated group; and the at least one second functional group, (Bii), comprises at least one functional group different than the ethylenically unsaturated group (Bi).

The first functional group, (Bi), comprising the ethylenically unsaturated compound of component (B), can be for example one or more (meth)acryloyl groups, vinyl groups, allyl groups, styryl groups, and mixtures thereof. In one preferred embodiment, the first functional group, (Bi), includes, for example, (meth)acryloyl groups; and mixtures thereof.

The second functional group, (Bii), of the ethylenically unsaturated compound, component (B), comprises a different group from the first functional group, (Bi); and the second functional group, (Bii), is capable of reacting with a crosslinker component. However, the crosslinker component that is reactive with the second functional group, (Bii), is not reactive with component (A) or with the first functional group (Bi) during free-radical polymerization. For example, the second functional group, (Bii), can be one or more epoxy groups, glycidyl groups, ketone groups, carbodiimide groups, aldehyde groups, acetoacetate groups, and mixtures thereof. In one preferred embodiment, the second functional group, (Bii), includes ketone groups, aldehyde groups, acetoacetate groups, and mixtures thereof. In another preferred embodiment, the second functional group, (Bii), includes ketone groups, aldehyde groups, and mixtures thereof.

In one preferred embodiment, component (B) includes, for example, compounds such as glycidyl (meth)acrylate; cyclohexylcarbodiimidoethyl methacrylate; acrolein; methacrolein; vinyl methyl ketone; vinyl ethyl ketone; vinyl isobutyl ketone; vinyl amyl ketone; diacetone acrylamide (N-(1,1-dimethyl-3-oxobutyl)-acrylamide); 2-[(2-methyl-1-oxo-2-propenyl)oxy]ethyl 3-oxobutanoate; and mixtures thereof. In another preferred embodiment, component (B) includes diacetone acrylamide (N-(1,1-dimethyl-3-oxobutyl)-acrylamide). Two or more components (B) having one or more different functional groups selected from the above components (Bi) and (Bii) may be used, provided that any one of the two or more components (B) does not react with another different component (B) except by reaction of the functional group (Bi) in free-radical polymerization.

The concentration of the at least one ethylenically unsaturated compound (B) used in the waterborne PPD composition is from 0.25 wt % to 10 wt % in one general embodiment; from 0.5 wt % to 7 wt % in another embodiment; and from 0.5 wt % to 5 wt % in still another embodiment based on the weight percentage of the total monomer units comprising the polymer.

The waterborne PPD composition of the present invention is produced by emulsion polymerization in an aqueous medium, component (C). The aqueous medium can include any type of water, for example, deionized water, distilled water, and the like; and the water can be obtained from any conventional source. In some embodiments, the water can be 100% water or a combination of a majority of water (e.g., 95% or more) with a smaller amount (e.g., 5% or less) of another component. For example, in some embodiments, the other component can be a chelating agent such as tetrasodium ethylenediaminetetraacetate which is added to the aqueous medium. In other embodiments, the water can include another component such as a solvent. The solvent can include, for example but is not limited to: toluene, acetone, methylethylketone, cyclohexane, ethylene glycol dimethyl ether, ethylene glycol diethyl ether, ethylene glycol methyl ether, diethylene glycol dimethyl ether, diethylene glycol diethyl ether, diethylene glycol methyl ether, dimethylformamide, dimethyl sulfoxide, monohydric alcohols such as methanol and ethanol, polyhydric alcohols such as glycerol, and mixtures thereof. In a preferred embodiment, the polymer latex composition is free of non-aqueous solvents. The aqueous medium may further comprise surfactants, acids, bases, salts, and decomposition products generated during the emulsion polymerization process.

To form the waterborne PPD composition by emulsion polymerization, the emulsion polymerization of monomers in an aqueous medium is conducted in the presence of component (D), at least one surfactant salt with a pKaH value of from 2.6 to 7. The surfactant, component (D), is referred to as a salt with the recognition by the skilled artisan that the surfactant can exist as a mixture of acid and salt forms depending on the pH of the medium containing the surfactant according to its acid-base equilibrium. In some embodiments, the surfactant molecule contains 10 or more carbon atoms (i.e., ≥C10 or C₁₀). For example, the surfactant salt, component (D), includes an alkali metal salt, an ammonia salt, a tertiary amino salt of an amphiphilic acid, and mixtures thereof. The pKaH of the surfactant salt is from 2.6 to 7 in one general embodiment, from 3.5 to 7 in another embodiment, and from 4.5 to 7 in another embodiment. The carbon atoms of the surfactant molecule may range from C10 to C150 in one embodiment, from C12 to C50 in another embodiment, and from C14 to C40 in still another embodiment. It is theorized that when the number of carbon atoms in the surfactant is less than C10, the surfactant may have insufficient ability to emulsify monomers in water to accomplish the emulsion polymerization or to stabilize the polymer particles of the PPD.

The surfactant can have two groups with a pKaH between 2.6-7. The surfactant can have one group with a pKaH between 2.6-7 and a group with a pKaH greater than 7. The composition can be free of surfactant with one or more groups with a pKaH between 2.6-7 and one or more groups less than 2.6.

The surfactant salt may be formed in-situ by reaction of an acid with a neutralizing agent. In one embodiment, the surfactant may be selected from the group of alkali metal salts, ammonia salts, and tertiary amino salts of N-acyl amino carboxylic acids; lactylic esters of carboxylic acids; and mixtures thereof. The acyl groups of the surfactant are based on C₈ to C₂₂ carboxylic acids, and mixtures thereof. The C₈ to C₂₂ carboxylic acids may include, for example, oleic acid, elaidic acid, octanoic acid, nonanoic acid, capric acid, undecanoic acid, lauric acid, myristic acid, palmitic acid, stearic acid, iso-stearic acid, arachidic acid, behenic acid, linoleic acid, erucic acid, and mixtures thereof.

In another embodiment, the N-acyl amino acid salt surfactants useful in the present invention include salts of N-acyl sarcosine such as N-lauroyl sarcosine, N-cocoyl sarcosine, N-myristoyl sarcosine, N-oleoyl sarcosine, and mixtures thereof; N-acyl glycine such as N-lauroyl glycine, N-cocoyl glycine, N-myristoyl glycine, N-oleoyl glycine, and mixtures thereof; N-acyl alanine such as N-lauroyl alanine, N-cocoyl alanine, N-myristoyl alanine, N-oleoyl alanine, and mixtures thereof; N-acyl glutamic acid such as N-lauroyl glutamic acid, N-cocoyl glutamic acid, N-myristoyl glutamic acid, N-oleoyl glutamic acid; and mixtures of two or more thereof.

In still another embodiment, the salt surfactants useful in the present invention include salts derived from lactylic esters of C₈ to C22 carboxylic acids including, for example, salts of lauroyl lactylate, stearoyl lactylate, behenyl lactylate, palmitoyl lactylate, isostearoyl lactylate, myristoyl lactylate, and mixtures thereof. The lactylic esters of C₈ to C₂₂ carboxylic acids are understood to include both pure lactylates such as lauroyl 1-lactylate, lauroyl 2-lactylate, and lauroyl 3-lactylate as well as mixtures of polylactylys. In one general embodiment, the number of lactyl groups in the lactylic ester ranges from 1 to 3. In other embodiments, combinations of N-acyl amino acid salt surfactants and salt surfactants derived from lactylic esters of C₈ to C₂₂ carboxylic acids can be used in the present invention.

In an embodiment, the surfactant useful in the present invention can be selected from the group of alkali metal salts, ammonia salts, and tertiary amino salts of alkyl ether carboxylic acids. The alkyl ether carboxylic acid has the general formula of R—(OCH₂CH₂)ₙ—OCH²COOH, where R is the alkyl chain. The alkyl chain, R, of the surfactant is based on C₈ to C₂₂ alkyl chains, and mixtures thereof. The alkyl chain may be linear or branched. The alkyl chain may be aliphatic or contain one cis or trans double bond. The alkyl ether carboxylic acid has n selected from 3 to 50, or from 3 to 20, or from 3 to 12. In other embodiments, combinations of two or more of N-acyl amino acid salt surfactants, salt surfactants derived from lactylic esters of C₈ to C22 carboxylic acids, and salt surfactants derived from alkyl ether carboxylic acids can be used in the present invention.

In some embodiments, the surfactant useful in the present invention can be selected from commercially available surfactant products. For example, the surfactant used to form the blend composition can include Geropon LG 3S and Geropon CG 3S (both available from Solvay); SLL-FB (available from Stepan); Dermol SLLC-L (available from Alzo International); Pationic ISL 85% (available from Rita Corporation); Hamposyl L, Hamposyl O, Hamposyl S, Hamposyl C, and Hamposyl M (all available from Chattem Chemical); Empicol CBJ; Empicol CED5, and Pureact T-A (all available from Innospec); Akypo RCO 105 and Akypo RO 20 VG (all available from Kao); and mixtures thereof.

The concentration of the surfactant used in the blend composition is from 0.15 weight percent (wt %) to 5 wt % in one general embodiment; from 0.25 wt % to 1.5 wt % in another embodiment; and from 0.45 wt % to 1 wt % in still another embodiment based on the dry weight % of the surfactant relative to the total weight of the monomer units in the PPD.

Although the waterborne PPD composition of the present invention, in one general embodiment, includes components (A) to (D), the waterborne PPD composition may also be formulated further with one or more optional additives, component (E). The optional components, component (E), useful in the present invention can be selected from a wide variety of optional additives to enable performance of specific functions while maintaining the excellent benefits/properties/performance of the present invention waterborne PPD composition. For instance, in some embodiments, the optional additives, component (E), useful in the waterborne PPD composition may include nonlimiting examples of suitable additives including for example, other monomers components different from Component (A) and Component (B), other surfactants different from component (D), molecular regulators or chain-transfer agents, tackifiers, plasticizers, neutralizing agents, thickeners, defoamers, wetting agents, mechanical stabilizers, pigments, fillers, freeze-thaw agents, adhesion promoters, biocides, and combinations thereof.

In some embodiments, the waterborne PPD composition may include one or more optional monomer component(s) different from Component (A) and Component (B). For example, in one embodiment, the optional monomer component(s) comprise optional acid monomer components such as α,β-monoethylenically unsaturated monocarboxylic acids of C3 to C8 carbon atoms such as acrylic acid, methacrylic acid, crotonic acid, and isocrotonic acid; α,β-monoethylenically unsaturated dicarboxylic acids of 3 to 6 carbon atoms, such as itaconic acid, fumaric acid and maleic acid; and the anhydrides of mono-olefinically unsaturated dicarboxylic acids, such as maleic anhydride and itaconic anhydride; or a monoethylenically unsaturated sulfonic acid such as vinylsulfonic acid, methallylsulfonic acid, and 2-acrylamido-2-methylpropanesulfonic acid; and mixtures thereof. In an embodiment, the optional acid monomer components comprise less than 0.5% or less than 0.26% or less than 0.1% of monomer of the total monomer units of the waterborne PPD by weight.

In another embodiment, the one or more optional monomer component(s) different from Component (A) and Component (B) may comprise, for example, a vinylaromatic monomer such as styrene, α-methylstyrene, vinyltoluene, 4-n-butylstyrene, and 4-tert-butylstyrene, a vinyl ester of an aliphatic C2-C10 carboxylic acid such as vinyl acetate and vinyl propionate; and mixtures thereof.

In still another embodiment, the one or more optional monomer component(s) different from Component (A) and Component (B) may comprise a monoethylenically unsaturated nitrile such as acrylonitrile, methacrylonitrile, and mixtures thereof.

In yet another embodiment, the one or more optional monomer component(s) different from Component (A) and Component (B) may comprise unsaturated monomers including for example, an amide of a monoethylenically unsaturated C3-C8 monocarboxylic acid such as acrylamide and methacrylamide; a hydroxy-C2-C4 alkyl ester of a monoethylenically unsaturated C3-C8 monocarboxylic acid, more particularly a C2-C4 hydroxyalkyl acrylate and methacrylate such as 2-hydroxyethyl acrylate, 2-hydroxyethyl methacrylate, 2-hydroxypropyl acrylate, 2-hydroxypropyl methacrylate, 3-hydroxypropyl acrylate, 3-hydroxypropyl methacrylate, 4-hydroxybutyl acrylate, and 4-hydroxybutyl methacrylate; and mixtures thereof.

In some preferred embodiments, the one or more optional monomer component(s) different from Component (A) and Component (B) is, for example, styrene, 2-hydroxyethyl methacrylate, 2-hydroxyethyl acrylate, and combinations thereof.

The concentration of the one or more optional monomer component(s) different from Component (A) and Component (B) used in the blend composition can be, for example, from 0 wt % to 44.5 wt % in one general embodiment; from 0.01 wt % to 44 wt % in another embodiment; from 0.01 wt % to 25 wt % in still another embodiment; and from 0.01 wt % to 3 wt % in yet another embodiment based on the dry weight % of the surfactant relative to the total weight of the monomer units in the PPD.

In another embodiment, the waterborne PPD includes, in addition to the aforementioned monomers, a small amount of optional polyethylenically unsaturated monomer, which when the polymer is prepared results in crosslinking. Nonlimiting examples of optional polyethylenically unsaturated monomers include diesters and triesters of ethylenically unsaturated carboxylic acids, more particularly the bis- and trisacrylates of diols or polyols having three or more OH groups, nonlimiting examples being the bisacrylates and the bismethacrylates of ethylene glycol, diethylene glycol, triethylene glycol, neopentyl glycol or polyethylene glycols, vinyl and allyl esters of saturated or unsaturated dicarboxylic acids, the vinyl and allyl esters of monoethylenically unsaturated monocarboxylic acids, and polyethylenically unsaturated aromatic monomers such as divinylbenzene. The fraction of the optional polyethylenically unsaturated monomers, does not exceed, based upon the total weight of monomers in the monomer mixture, 1 wt % in one general embodiment, or 0.5 wt % in another embodiment, or 0.1 wt % in still another embodiment. In other embodiments, the or from 0.1 wt % fraction of the optional polyethylenically unsaturated monomers can be from 0.01 wt % to 1 wt %.

In some embodiments, the waterborne PPD composition may include one or more surfactant(s) different from Component (D). The optional surfactants may be anionic surfactants or nonionic surfactants or a mixture thereof. For example, the optional anionic surfactants may include sulfonates, carboxylates, phosphates, their ethoxylated derivates, and combinations thereof. For example, the optional nonionic surfactants may include block copolymers containing ethylene oxide or propylene oxide, ethoxylated and propoxylated alcohols, ethoxylated and propoxylated fatty acids, sorbitan derivatives, lanolin derivatives, ethoxylated nonylphenols, ethoxylated octylphenols, or alkoxylated polysiloxanes, and combinations thereof.

In other embodiments, the optional surfactant can include Aerosol A-102, Aerosol OT-75, Rhodacal DS-4 (available from Solvay); DOWFAX™ 2A1 and TERGITOL™ 15-S-40 (available from The Dow Chemical Company); Polystep B-3 and Polystep B-11 (available from Stepan); and mixtures thereof. The waterborne PPD composition of the present invention can contain from 0 wt % to 2 wt % of the optional surfactant(s) different from component (D) in one general embodiment, from 0 wt % to 1 wt % in another embodiment, from 0.02 wt % to 0.5 wt % in still another embodiment, from 0.05 wt % to 0.2 wt % in yet another embodiment, and from 0 wt % to 0.2 wt % in even still another embodiment, based on total dry weight of the waterborne PPD composition in one embodiment. In an embodiment, the waterborne PPD composition contains less than 0.1 wt % of optional surfactant based on total dry weight of the waterborne PPD composition. In one general embodiment, the ratio of the dry weight of the component (D) to the dry weight of the optional surfactant(s) different from component (D), if present, is from 1:1 to 1:0.01, from 1:0.5 to 1:0.02 in another embodiment, or from 1:0.2 to 1:0.05 in still another embodiment.

For example, in some embodiments, molecular regulators or chain-transfer agents can be used in the polymerization in the amounts from 0 wt % to 5 wt % in one general embodiment and from 0.1 wt % to 2 wt % in another embodiment, based on the monomers to be polymerized. Using the above regulators, the molecular weight of the polymer can be reduced. A particular molecular weight of the polymer dispersion can be targeted by controlling the ratio of the monomers to the amount of regulator, with greater amounts of the regulator resulting in polymers of lower molecular weight. Suitable chemical regulators useful in the present invention include, for example, compounds possessing a thiol group such as tert-butyl mercaptan, mercaptoethanol, thioglycolic acid, thioglycolic acid ethyl ester, mercaptopropyl-trimethoxysilane, and tert-dodecyl mercaptan, n-dodecyl mercaptan (n-DDM), 3-mercaptopropionic acid, and its esters such as methyl 3-mercaptopropionate (MMP) and butyl 3-mercaptopropionate; and mixtures thereof. In one embodiment, the regulator is a transition metal chelate complex such as a cobalt (II) or (III) chelate complex. The regulator can be added throughout the entire course of the emulsion polymerization, for example by adding the regulator to the monomer emulsion to be fed continually to a reactor. Alternatively, the regulator can be added separately at any time during the reaction to be fed at a continuous or varying rate.

In some embodiments, the waterborne PPD composition may optionally include, for example, a tackifier which is different than the precursor polymer. For example, suitable tackifiers include, but are not limited to, rosin resins. The rosin resins can include, for example, rosin acid; a rosin ester obtained by esterifying rosin acid with an alcohol compound, an epoxy compound, or a mixture of alcohol and epoxy compounds; non-hydrogenated aliphatic C₅ resins; hydrogenated aliphatic C₅ resins; aromatic modified C₅ resins; terpene resins; hydrogenated C₉ resins; (meth)acrylic resins; and combinations thereof. (Meth)acrylic resins suitable as tackifiers include, for example, the tackifiers described in U.S. Pat. Nos. 4,912,169; 9,605,188; and U.S. Patent Application Publication No. 2002/055587. In some embodiments, the waterborne PPD composition of the present invention can contain, for example, from 0 wt % to 50 wt % of the optional tackifier in one general embodiment, from 1 wt % to 50 wt % in another embodiment, from 5 wt % to 40 wt % in still another embodiment, from 7 wt % to 30 wt % in yet another embodiment, and from 8 wt % to 15 wt % in even still another embodiment, based on total dry weight of the waterborne PPD composition in one embodiment.

In some embodiments, the waterborne PPD composition may include a plasticizer as an optional component. For example, the optional plasticizers may include benzoate esters; phthalate esters; cyclohexane-1,2-dicarboxylate esters; terephthalate esters; trimellitate esters; adipate esters; sebacate esters; maleate esters; citrate esters; and combinations thereof. In an embodiment, the plasticizer may be a glycol benzoate, such as a dipropylene glycol dibenzoate, a diethylene glycol dibenzoate, 2-ethyl hexyl monobenzoate, modified dibenzoate, and a mixture thereof. In an embodiment, the optional plasticizer can include Benzoflex 2088, Benzoflex 50, Benzoflex 9-88 (all available from Eastman); PARAPLEX™ WP-1 (available from The Dow Chemical Company); Santicizer 160 (available from Valtris Specialty Chemicals); and mixtures thereof. The waterborne PPD composition of the present invention can contain from 0 wt % to 20 wt % of the optional plasticizer in one general embodiment, from 1 wt % to 20 wt % in another embodiment, from 2 wt % to 15 wt % in still another embodiment, from 5 wt % to 12 wt % in yet another embodiment, and from 5 wt % to 10 wt % in even still another embodiment, based on total dry weight of the waterborne PPD composition in one embodiment.

In some embodiments, the waterborne PPD composition of the present invention may include a neutralizing agent as an optional component. Examples of neutralizing agent useful in the present invention include, but are not limited to, ammonium hydroxide, sodium hydroxide, potassium hydroxide, triethanolamine, and mixtures thereof. A preferred neutralizing agent (or base) is, for example, ammonia. In one general embodiment, the waterborne PPD composition can include from 0 wt % to 5 wt % neutralizing agent and from 0.1 wt % to 5 wt % neutralizing agent in another embodiment, based on the total dry weight of the waterborne PPD composition.

In some embodiments, the waterborne PPD composition of the present invention may include an acid or salt as an optional component. The acid may be reacted with the neutralizing agent to form a salt in situ. Examples of acids or salts useful in the present invention include, but are not limited to: citric acid, sodium citrate, ammonium citrate, phosphoric acid, sodium phosphate, sodium hydrogen phosphate, sodium dihydrogen phosphate, tetrasodium pyrophosphate, ammonium phosphate, sulfuric acid, sodium sulfate, ammonium sulfate, lactic acid, sodium lactate, ammonium lactate, acetic acid, sodium acetate, ammonium acetate, sodium carbonate, sodium bicarbonate, ammonium bicarbonate, glycine, boric acid, ammonium borate, sodium borate, and mixtures thereof. In one general embodiment, the waterborne PPD composition can include from 0 wt % to 5 wt % acids and/or salts; from 0.1 wt % to 5 wt % acids and/or salts in another embodiment; from 0.1 wt % to 3 wt % acids and/or salts in still another embodiment; and from 0.1 wt % to 2 wt % acids and/or salts in yet another embodiment, based on the total dry weight of the waterborne PPD composition.

In some embodiments, the waterborne PPD composition may include a thickener optional component. For example, suitable thickeners useful in the present invention include, but are not limited to, ACRYSOL™, UCAR™ and CELLOSIZE™ which are thickeners commercially available from The Dow Chemical Company, Midland, Michigan. Additional examples of thickeners useful in the present invention include, but are not limited to ACRYSOL™ RM-2020E, ACRYSOL™ RM-8W, ACRYSOL™ RM-845, ACRYSOL™ ASE-60, ACRYSOL™ DR-5500 (all available from The Dow Chemical Company); Rheovis PE 1331 and Rheovis VP 1231 (all available from BASF); Vismody U902 (available from Wamhur); and Polyvinylpyrrolidone K-90 (available from Ashland). In one general embodiment, the waterborne PPD composition can include from 0 wt % to 5 wt % of an optional thickener and from 0.1 wt % to 5 wt % optional thickener in another embodiment, based on the total dry weight of the waterborne PPD composition.

The waterborne PPD composition of the present invention exhibits several advantageous properties and benefits. For example, the waterborne PPD composition, prior to being combined with a crosslinking agent to form a waterborne CAPD composition, can: (1) be used in an aqueous medium; (2) be formulated and used at a pH of less than 7.5; (3) exhibit instant tack; and (4) be applied by spraying.

The waterborne PPD composition of the present invention may have a pH in the range of 3 to 7.5 in one general embodiment, from 4.5 to 7.5 in another embodiment, and from 5 to 7.5 in still another embodiment.

The waterborne PPD composition of the present invention may have a dry solids content in the range of from 45% to 73% in one general embodiment, from 48% to 70% in another embodiment, from 50% to 68% in still another embodiment, and from 60% to 73% in yet another embodiment.

The waterborne PPD composition of the present invention may have a viscosity in the range of from 0 mPa-s to 10,000 mPa-s in one general embodiment, from 5 mPa-s to 2500 mPa-s in another embodiment, and from 10 mPa-s to 1500 mPa-s in still another embodiment.

The waterborne PPD composition of the present invention may have a (meth)acrylic polymer Tg in the range of from −10° C. to −80° C. in one general embodiment, from −20° C. to −70° C. in another embodiment, and from −30° C. to −60° C. in still another embodiment, where the Tg is estimated as described in the examples from the constituent monomers of the meth(acrylic) polymer in the PPD which is polymerized from the component (A), component (B), and optional monomer components

The waterborne PPD composition of the present invention may have a (meth)acrylic polymer number average molecular weight, Mn, from 10,000 Da to 5,000,000 Da in one general embodiment, from 50,000 Da, to 1,000,000 Da in another embodiment, from 50,000 Da to 500,000 Da in still another embodiment, from 50,000 Da to 250,000 Da in yet another embodiment, and from 75,000 Da to 125,000 Da in even still another embodiment. The waterborne PPD composition of the present invention may have a weight average molecular weight, Mw, from 50,000 Da to 5,000,000 Da in one general embodiment, from 250,000 Da, to 2,000,000 Da in another embodiment, and from 300,000 Da to 750,000 Da in still another embodiment, where the Mn and Mw refer to the molecular weight of the meth(acrylic) polymer in the PPD which is polymerized from the component (A), component (B), and optional monomer components.

In a general embodiment, the process for preparing the waterborne PPD composition includes, subjecting the mixture of components (A) to (D) to free-radical emulsion polymerization to form the waterborne PPD composition. In a preferred embodiment, the process for preparing the waterborne PPD composition comprises polymerizing, by free-radical emulsion polymerization, the monomer mixture comprising: (A) at least one alkyl (meth)acrylate; and (B) at least one ethylenically unsaturated compound comprising: (Bi) at least one first functional group; wherein the at least one first functional group comprises at least one ethylenically unsaturated group; and (Bii) at least one second functional group; wherein the at least one second functional group comprises at least one functional group different than the ethylenically unsaturated group; wherein the second functional group is capable of reacting with a crosslinker component; and wherein the crosslinker component is not reactive with component (A) in free-radical polymerization; in the presence of: (C) an aqueous medium; and (D) at least one acid surfactant salt with pKaH from 2.6 to 7.

The free-radical polymerization of the mixture of components (A) to (D) to form the resultant polymerized polymer in the aqueous PPD composition is initiated with an initiator component (F). The initiator, component (F), is added to the mixture of components (A) to (D) to initiate the emulsion polymerization reaction under polymerization conditions such as mixing the components including the initiator at a temperature of from 30° C. to 130° C. in one general embodiment.

In some embodiments, the initiators useful in the present invention for the emulsion polymerization are typically water-soluble substances that form free radicals. Water-soluble initiators for the emulsion polymerization can be organic or inorganic peroxide compounds, i.e., compounds having at least one peroxide or hydroperoxide group, examples include ammonium salts and alkali metal salts of peroxodisulfuric acid, e.g., sodium peroxodisulfate, hydrogen peroxide, or organic peroxides such as tert-butyl hydroperoxide. The initiator can also be a reduction-oxidation (redox) initiator system. The redox initiator systems are composed of at least one, usually inorganic reducing agent and one organic or inorganic oxidizing agent. The oxidizing component can be composed of, for example, the peroxide compounds stated above. The reducing components are comprised, for example, of alkali metal salts of sulfurous acid, such as sodium sulfite, sodium hydrogen sulfite, alkali metals salts of disulfurous acid such as sodium disulfite, bisulfite addition compounds with aliphatic aldehydes and ketone, such as acetone bisulfite, or reducing agents such as hydroxymethanesulfinic acid and its salts, BRUGGOLITE FF6 (available from Bruggeman), or ascorbic acid. Then redox initiator system can be used in combination with soluble metal compounds. The typical redox initiator pairs are, for example, ascorbic acid/iron(II) sulfate/sodium peroxidisulfate, and tert-butyl hydroperoxide/sodium disulfite, tert-butyl hydroperoxide/sodium hydroxymethanesulfinic acid; and mixtures thereof.

The amount of initiator is generally from 0.1 wt % to 10 wt % in one embodiment and from 0.3 wt % to 5 wt % in another embodiment, based on the monomers to be polymerized. It is also possible to use two or more different initiators in the same emulsion polymerization.

For preparing the aqueous PPD of the present invention, in principle, it is possible to use various processes for preparing the aqueous PPDs having a unimodal or a polymodal particle size distribution. Nonlimiting examples of suitable processes useful for preparing the aqueous PPD of the present invention include a process of mixing two or more different polymer dispersions with unique monomodal or polymodal particle size distribution(s) wherein the particles differ in average particle size. Another suitable process to prepare the aqueous PPD is by way of a free-radical aqueous emulsion polymerization of ethylenically unsaturated monomers in the presence of two or more different seed latices. The average particle size of the seed latices can differ. Another suitable process that may be employed for preparing the aqueous PPD of the present invention is to carry out a free-radical aqueous emulsion polymerization of the monomers by a feed process and during the course of the polymerization, when some of the monomers have already undergone polymerization, a larger quantity of emulsifier is added, (e.g., a surfactant intercept), which initiates the formation of a new particle generation. Another suitable process that may be employed for preparing the aqueous PPD of the present invention is to carry out a free-radical aqueous emulsion polymerization of the monomers by a feed process and during the course of the polymerization an excess quantity of emulsifier can be fed to a polymerization reactor such that new particles are formed throughout the polymerization to yield a polymodal particle size distribution of the aqueous PPD.

In one embodiment, the aqueous PPD of the present invention is provided by way of a free-radical aqueous emulsion polymerization of the monomers which includes the aqueous polymer dispersion. In this process, a free radical, aqueous emulsion polymerization of the ethylenically unsaturated monomers is carried out according to a monomer feed process in which at least one seed latex (α) is included in the initial charge to the polymerization reactor, and at least one further seed latex (β), in the form of an aqueous dispersion, is added during course of the polymerization. The seed latex (β) is added to the polymerization reactor continuously during the monomer feed. Alternatively, the seed latex (β) is added to the polymerization reactor during a discrete interval at a defined point during the monomer feed. In an embodiment, the seed latex (β) is added to the polymerization reactor at a defined point when 20% to 60% of the total amount of monomer has been added to the polymerization reactor. The interval over which the seed latex (β) is added to the polymerization reactor is less than fifteen min in one embodiment, less than 10 min in another embodiment, and less than 5 min in still another embodiment.

The term “seed latex” is understood to refer to an aqueous polymer dispersion. In an embodiment, the weight-average particle size of the seed latexes used in the process of the present invention (weight average, d₅₀) is less than 500 nm, or from 10 to 400 nm, or from 30 to 250 nm. The initial seed latex or latexes A, located in the polymerization reactor at the start of the polymerization, have a weight-average particle size from 30 to 400 nm. As for the further seed latex (β), added in the course of the polymerization, the weight-average particle size is from 30 to 400 nm, or from 30 to 100 nm.

In some embodiments, the seed polymers are composed predominantly of vinyl aromatic monomers and more particularly of styrene (so-called styrene seed), or predominantly of C₁-C₁₀ alkyl acrylates and/or C₁-C₁₀ alkyl methacrylates, such as from a mixture of butyl acrylate and methyl methacrylate, for example. Besides these principal monomers, which typically account for at least 80 wt % and more particularly at least 90 wt % of the seed polymer, the seed polymers may include, in copolymerized form, monomers different from these, more particularly monomers having a heightened water solubility, nonlimiting examples being monomers having at least one acid function and/or neutral monomers with an increased water solubility. The fraction of such monomers will generally not exceed 20 wt % in one embodiment and will not exceed 10 wt % in another embodiment; and, where such monomers are present, the monomers are situated typically in the range from 0.1 wt % to 10 wt %, based on the total amount of the monomers which constitute the seed polymer.

The first seed polymer (α) is typically used in an amount from 0.05 wt % to 4 wt % in one embodiment, and from 0.2 wt % to 2 wt % in another embodiment, based on the total solids content of the seed polymer to amount of the monomers to be polymerized.

The seed polymer (β), added in the course of the polymerization reaction, is used in an amount from 0.05 wt % to 2 wt % in one embodiment and from 0.1 wt % to 1 wt % in another embodiment, based on the total solids content of the seed polymers to the total amount of the monomers to be polymerized.

Through the amount of the seed latex A and/or through the ratio of seed latex A to the monomers, it is possible to adjust the maximum particle size of the polymer particles in the dispersion. A small fraction of seed latex A, based on the monomers, leads in general to larger polymer particles, whereas a larger amount of seed latex A leads in general to smaller polymer particles. The time of the addition of the second seed latex, and the weight ratio of seed latex (β) to the monomers, are used to make adjustments, in particular, to the particle size and the weight fraction of the smaller polymer particles in the dispersion. The earlier the second seed latex (β) is added, the higher the fraction of smaller polymer particles in the polymer dispersion. At the same time, however, there is an increase in the size of the smaller particles, and so the d₁₀ figure on early addition of the seed latex (β) is larger than in the case of a later addition. Similar considerations apply to the amount of the seed latex (β). The larger the ratio of seed latex (β) to the monomers to be polymerized, the greater the fraction of smaller polymer particles and the greater the d₁₀ figure for the particle size distribution.

In some embodiments, the particles composed of (A) the first acrylic-based polymer and (B) the second acrylic-based polymer have a polymodal particle size distribution, a d₅₀ of greater than 450 nm and a polydispersity index, PDi, of from 0.5 to 2.0. In an embodiment, the particles composed of (A) the first acrylic-based polymer and (B) the second acrylic-based polymer have one, some, or all of the following properties:
(i) a d₅₀ of from 455 nm to 1.0 micron in one embodiment; and from 455 nm to 800 nm in another embodiment;
(ii) a PDi of from 0.5 to 2.0 in one embodiment; and from 0.5 to 1.8 in another embodiment; and/or
(iii) a d₉₀/d₁₀ of from 2.5 to 20.0 in one embodiment; and from 2.5 to 10.0 in another embodiment.

In some embodiments, the process of the present invention is performed as a feed process, i.e., at least 95% of the monomers to be polymerized are added to a polymerization reactor under polymerization conditions during the polymerization. The addition may be made continuously or in stages.

In some embodiments, the procedure in the process of the present invention is to: (1) provide water as an initial charge in the polymerization reactor, (2) add a portion of the polymerization initiator to the polymerization reactor, and then (3) charge the first seed latex or latexes (α) in the form of an aqueous dispersion, optionally together with water to the polymerization reactor. This is followed by the addition of the monomers to be polymerized to the polymerization reactor under polymerization conditions.

The addition of the monomers takes place typically over a period of from at least 30 min in one embodiment, over a period of from 30 min to 10 hr in another embodiment, and over a period of from 1 hr to 6 hr in still another embodiment. As already described, the addition may take place with a constant, an increasing, or a decreasing rate of addition. In another embodiment, the addition of the monomers takes place at the beginning of the polymerization, with an increasing feed rate. Alternatively, the addition of the monomers takes place with a constant addition rate. The monomers can be added “as is”, i.e., without modifying the monomers or used as received from a supplier. In a preferred embodiment, the monomers are added in the form of an aqueous monomer emulsion, which includes at least in part, at least 70% by weight, of the surface-active substances used in the emulsion polymerization. This monomer emulsion customarily has a monomer content in the range from 60% to 90% in one general embodiment. It is possible to add the monomers or the monomer emulsion to the polymerization reactor via two or more feed streams, it being possible for the monomer composition of the individual feed streams to be different from one another. In general, however, it is sufficient to add the monomers as a mixture via one feed stream into the polymerization reactor. Where the monomers are added to the polymerization reactor in the form of an aqueous emulsion, it is advantageous to provide fresh emulsification of the monomers immediately prior to the addition of the monomers and in line with the addition of the monomers in the polymerization reactor, by a continuous method, for example. It is also possible to prepare the monomer emulsion first of all and then to introduce the prepared monomer emulsion into the polymerization reactor at the desired addition rate.

In parallel with the addition of the monomers to the polymerization reactor, at least a portion of the entirety of the polymerization initiator can be added to the polymerization reactor. The polymerization initiator may be added at a constant rate, a decreasing rate, or an increasing rate, for example.

The emulsion polymerization takes place at a temperature from 30° C. to 130° C. in one embodiment, and from 50° C. to 90° C. in another embodiment. The polymerization pressure is situated typically in the region of atmospheric pressure, i.e., at ambient pressure, but may also be slightly above or below ambient pressure. For example, the polymerization pressure can be in the range from 80 kPa to 150 kPa in one general embodiment.

At the end of the addition of the monomers to be polymerized, or after a conversion of at least 95% of the monomers located in the polymerization reactor, a chemical and/or physical deodorization is performed for the purpose of removing unpolymerized monomers. A chemical deodorization is a post-polymerization phase which is initiated by addition of at least one further polymerization initiator, more particularly by way of one of the aforementioned redox initiator systems. In one embodiment, the chemical deodorization step may be combined with the second polymerization stage such that the feeding of the initiator continues after the feeding of the monomer to accomplish the chemical deodorization. The lowering of the residual monomers may also take place through combined measures of chemical and physical deodorization, in which case the physical deodorization is preferably carried out after the chemical deodorization. The PPDs thus obtained include less than 1,500 ppm of residual monomer species in one embodiment, less than 1,000 ppm of residual monomer species in another embodiment, and less than 500 ppm of residual monomer species in still another embodiment.

Before the polymer dispersion is used, a base or neutralizing agent is typically added to the polymer dispersion to adjust the pH of the polymer dispersion to a desired range as described above.

In a broad embodiment, the waterborne CAPD composition (which can also be referred to as “a polymer latex formulation”) of the present invention is a blend, combination, composite, or mixture of two or more components; and the waterborne CAPD composition includes, for example: (I) the above-described aqueous PPD composition obtained by emulsion polymerization; and (II) a crosslinking compound having at least two functional groups wherein at least two or more functional groups can crosslink with at least one of the components present in the aqueous PPD composition.

In a preferred embodiment, the waterborne CAPD composition of the present invention generally includes: (I) the aqueous PPD composition obtained by free-radical emulsion polymerization of a monomer mixture; and (II) a bifunctional or polyfunctional crosslinking compound which can crosslink with the at least one second functional group, component (Bii), of the at least one ethylenically unsaturated compound, component (B), of the waterborne PPD composition, component (I).

The waterborne PPD composition, component (I), used to form the waterborne CAPD composition is the crosslinkable waterborne PPD composition described above. In another embodiment, two or more waterborne PPD compositions differing from each other in composition, Tg, or molecular weight may be blended to provide component (I).

The amount of the crosslinkable waterborne PPD composition, component (I), used to produce the waterborne CAPD composition can be generally in the concentration range of from 50 wt % to 99.98 wt % in one embodiment; from 70 wt % to 99.9 wt % in another embodiment; and from 80 wt % to 98.5 wt % in still another embodiment, based on the dry weight of the PPD and the total dry weight of the CAPD.

In a general embodiment, the crosslinking agent or compound (bifunctional or polyfunctional crosslinker; component (II)) useful in forming the waterborne CAPD composition of the present invention comprises a crosslinker having at least two functional groups wherein at least two or more functional groups of the crosslinker, component (II), are capable of reacting with at least one of the functional groups, B(ii), of the component B.

In some embodiments, the functional groups of component (II) may be hydrazide groups, hydrazine groups, oxime ether groups, hydroxylamine groups, O-substituted hydroxylamine groups, amine groups, aldehyde groups, enamine groups, alcohol groups, and mixtures thereof. In one embodiment, the functional groups of component (II) include hydrazide groups, hydrazine groups, oxime ether groups, hydroxylamine groups, O-substituted hydroxylamine groups, and mixtures thereof.

In another embodiment, the functional groups of component (II) are hydrazide groups. Examples of polyfunctional components, component (II), include polyfunctional hydrazides of diacids such as oxalic acid, maleic acid, malonic acid, succinic acid, glutaric acid, adipic acid, and mixtures thereof.

In other embodiments, examples of component (II) include carbohydrazide; adipic dihydrazide; ethylmalonic acid dihydrazide; fumaric acid dihydrazide; tartaric acid dihydrazide; pimelic acid dihydrazide; itaconic acid dihydrazide; 9,10-dihydro-9,10-ethanoanthracene-11,12-dicarboxylic acid dihydrazide; 1,14-tetradecanoic dicarboxylacid dihydrazide; 1,20-icosanedioic acid dihydrazide; valine dihydrazide; orthophthalic acid dihydrazide; isophthalic acid dihydrazide; terephthalic acid dihydrazide; sebacic acid dihydrazide; cyclohexane dicarboxylic acid bis-hydrazides; azelaic acid bis-hydrazides; and mixtures thereof.

In other embodiments, a useful class of polyfunctional components used as component (II) include, for example, polyfunctional hydrazines such as dihydrazinoalkynones; dihydrazines of aromatic hydrocarbons such as 1,4-dihydrazinebenzene and 2,3-dihydrazinonaphthalene; and mixtures thereof.

In still other embodiments, polyfunctional components that may be used as component (II), may include polyfunctional amines such as ethylene diamine, 1,2-propylene diamine, 1,3-propylene diamine, and 1,6-hexanediamine; polyether diamines and triamines such as 1,8-diaminotriethyleneglycol; polyfunctional O-substituted hydroxylamines such as bis(aminoxy)polyethyleneglycol (PEG); polyfunctional enamines; polyfunctional aldehydes derived from the aforementioned diacids such as, for example, adipic dialdehyde, glutaric dialdehyde, succinic dialdehyde, and oxalic dialdehyde; polyfunctional alcohols such as ethylene glycol, propylene glycol, 1,4-butanediol, 1,6-hexanediol, and glycerol; and a combination of two or more of the above polyfunctional components. In one preferred embodiment, the component (II) is adipic dihydrazide.

As an illustration of non-limiting examples of the present invention, in some embodiments, polyfunctional hydrazides, hydrazines, oxime ethers, hydroxylamines, amines, enamines, and mixtures thereof may be used to react with at least one functional group selected from epoxy groups, glycidyl groups, aldehyde groups, ketone groups, acetoacetate groups, carbodiimide groups, and mixtures thereof, present in component (B) of the polymer present in the PPD. In some embodiments, polyfunctional aldehydes may be used when component (B) of the polymer present in the PPD contains acetoacetate groups. In some embodiments, polyfunctional alcohols are suitable for use when component (B) in the polymer of the PPD contains carbodiimide groups.

In other embodiments, a polyfunctional component (II) having two or more different functional groups present in component (II), may be employed in the present invention, provided that the two or more different functional groups present in component (II) do not react with one another; or provided that the polyfunctional component (II) having two or more different functional groups do not react with another component present in the PPD composition. In some embodiments of the present invention, two or more polyfunctional components may be used as component (II); and the functional groups on each of the two or more polyfunctional components are different from the functional groups present on other polyfunctional component(s), provided the polyfunctional components do not react with one another.

In some embodiments, the crosslinker used to form the waterborne CAPD composition of the present invention can be selected from conventional crosslinker products such as hydrazide-PEG-hydrazide (available from Creative PEGWorks); bis(aminooxy)-PEG (available from BroadPharm); Jeffamine EDR-148 (available from Huntsman); other conventional crosslinker products known in the art; and mixtures thereof.

The amount of the crosslinker, component (II), used to produce the waterborne CAPD composition can be generally in the concentration range of from 0.02 wt % to 5 wt % in one embodiment; from 0.05 wt % to 2 wt % in another embodiment; and from 0.15 wt % to 1 wt % in still another embodiment based on the dry weight of the component (II) and the total dry weight of the CAPD. At lower levels, there may be insufficient crosslinking to provide bonds strong enough to resist failure of the adhesive bond before the bonded substrate tears. At higher levels, the CAPD may become unstable to coagulation or crosslink so strongly that it does not adhere to the substrate.

Although the waterborne CAPD composition of the present invention, in one general embodiment, includes components (I) to (II), the waterborne CAPD composition may also be formulated further with one or more optional additives, component (III). The optional components, component (III), useful in the present invention can be selected from a wide variety of optional additives to enable performance of specific functions while maintaining the excellent benefits/properties/performance of the present invention waterborne CAPD composition. For instance, in some embodiments, the optional additives, component (III), useful in the waterborne CAPD composition may include nonlimiting examples of suitable additives including for example, aqueous polymer dispersions different from component (I), acids, salts, or combinations thereof.

In some embodiments, the waterborne CAPD composition may also be formulated further with one or more aqueous polymer dispersions different from component (I). The aqueous polymer dispersions different from component (I) can include, for example, natural rubber, synthetic rubber, acrylic polymers, and mixtures thereof. The synthetic rubber may include homopolymers of butadiene, isoprene, or dimethyl butadiene. Other useful synthetic rubbers include copolymers of butadiene and styrene, isoprene and styrene, butadiene and dimethyl butadiene, butadiene and acrylonitrile, isoprene and acrylonitrile, dimethyl butadiene and styrene, butadiene and vinyl toluene, or isoprene and vinyl toluene. The acrylic polymer may include homopolymers and copolymers of monomers including, but not limited to, alkyl (meth)acrylates, monoethylenically unsaturated monomers having an acid group, vinylaromatic monomers, unsaturated nitrile monomers, vinyl ester monomers, unsaturated amide monomers, hydroxy alkyl (meth)acrylate monomers, and mixtures thereof. In an embodiment, the pH of the aqueous polymer dispersion different from component (I) is lower than the pH of the waterborne PPD. Suitable aqueous polymer dispersions different from component (I) useful in the present invention include, but are not limited to, acrylic latex such as INVISU™ 3000 (an acrylic adhesive available from The Dow Chemical Company). The amount of the optional aqueous polymer dispersion used to produce the waterborne CAPD composition can be generally in the concentration range of from 0 wt % to 50 wt % in one embodiment; from 0 wt % to 35 wt % in another embodiment; and from 0 wt % to 20 wt % in still another embodiment based on the dry weight of the optional aqueous polymer dispersion and the total dry weight of the CAPD.

It has been found that blending aqueous solutions of some acids such as hydrochloric acid, acetic acid, and citric acid with the waterborne PPD to form the CAPD may destabilize the waterborne PPD to form coagulum. Therefore, it is difficult to adjust the pH of the waterborne PPD down to a low pH in the CAPD by simply adding aqueous acid solutions to the waterborne PPD because aqueous acid solutions tend to shock the waterborne PPD and cause coagulation. In some embodiments of the present invention, aqueous solutions of boric acid may be used to lower the pH of the waterborne PPD to form a CAPD with lower pH with little or no coagulation. In other embodiments of the present invention, polymer dispersions with lower pH than the waterborne PPD may be used to lower the pH of the waterborne PPD to form a CAPD with lower pH with little or no coagulation.

The waterborne CAPD composition of the present invention exhibits several advantageous properties and benefits when used to bond to pieces of substrates together. For example, the waterborne CAPD composition has the following properties: (1) the waterborne CAPD composition does not contain (poly)chloroprene; and therefore the waterborne CAPD composition is less detrimental to the environmental and health of users of the adhesive; (2) the waterborne CAPD composition is fast-setting, viz, the waterborne CAPD composition sets within a fast period of time; (3) be used in an aqueous medium; (4) be formulated and used at a pH of less than 7.5; (5) have a high bond strength (e.g., an adhesive strength sufficient to pass a conventional adhesion test); (6) within 60 min form bonds strong enough to resist failure of the adhesive bond before the bonded substrate (e.g., a conventional polyurethane foam) tears; and (7) can be applied by spraying.

The fast-setting property of the waterborne CAPD composition includes, for example, a period of time of less than 60 min in one general embodiment, less than 20 min in another embodiments, less than 10 min in still another embodiment, and less than 5 min in yet another embodiment. In other embodiments, the waterborne CAPD composition sets within a period of time of from 5 s to 30 min in one embodiment, from 10 s to 10 min in another embodiment, and from 20 s to 5 min in still another embodiment. The fast-setting property of the waterborne CAPD composition refers to its ability to resist debonding when an article bonded with the waterborne CAPD composition is pulled apart with a fingertip force within the given period of time. The fast-setting property of the waterborne CAPD composition enables the bonded article to be handled and processed rapidly after bonding.

The waterborne PPD composition of the present invention may have a pH in the range of from 3 to 7.5 in one embodiment, or from 4.5 to 7.5 in another embodiment, or from 5 to 7.5 in still another embodiment.

The waterborne PPD composition of the present invention may have a dry solids content in the range of from 45% to 73% in one embodiment, or from 48% to 70% in another embodiment, or from 50% to 68% in still another embodiment.

The waterborne PPD composition of the present invention may have a viscosity in the range of 0 mPa-s to 10,000 mPa-s in one embodiment, or from 5 mPa-s to 2500 mPa-s in another embodiment, or from 10 mPa-s to 1,500 mPa-s in still another embodiment.

In a general embodiment, the waterborne CAPD composition of the present invention is formed by admixing, blending, mixing: (I) the crosslinkable waterborne PPD composition described above; and (II) the bifunctional crosslinker described above; and any other optional components as desired, to form a uniform mixture, formulation or composition.

In a preferred embodiment, the process for preparing the waterborne CAPD composition includes mixing: the waterborne PPD composition, component (I), with the crosslinker compound, component (II), and optionally with component (III), using conventional mixing processes and mixing equipment.

The process for forming the waterborne CAPD composition includes, for example, mixing the components (I) and (II) together in the desired concentrations discussed above; and then any one or more additional optional components (III) may be added to the waterborne CAPD composition as desired. The order of mixing components (I) and (II), and any optional components, component (III), is not critical; and two or more components can be mixed together followed by addition of the remaining components. The waterborne CAPD composition components may be mixed together by any conventional mixing process and mixing equipment. For example, component (I) and (II), and optional component (III), can be mixed in a standard tank with a conventional blade agitator to form the waterborne CAPD composition.

In one general embodiment of the present invention, the waterborne CAPD composition can be used to bond two surfaces of a single substrate to itself, for example, by folding a single substrate such that a folded substrate structure is formed, and then contacting the two surfaces of the single folded substrate structure with each other having a layer of the waterborne CAPD composition in between the two surfaces of the folded substrate structure.

In general, the process of adhering two surfaces of a first single workpiece includes the following steps:
Step (a) providing a waterborne CAPD composition described above;
Step (b) providing at least a first workpiece to be bonded;
Step (c) applying the waterborne CAPD composition to at least a portion of the surface of the at least first workpiece to form at least one layer of the waterborne CAPD composition disposed on the surface of the first workpiece to be bonded to itself;
Step (d) folding the first workpiece such that the layer of the waterborne CAPD composition is disposed in between two surfaces of the folded first workpiece;
Step (e) optionally, drying, or allowing to dry, the at least one layer of the waterborne CAPD composition;
Step (f) contacting the two surfaces of the first workpiece together with the at least one layer of the waterborne CAPD composition disposed in between the surfaces to bond the first workpiece to itself; and
Step (g) drying, or allowing to dry, the at least one layer of the waterborne CAPD composition disposed in between the surfaces to form an adhesive bond.

In the case that only one workpiece is used, distinct surfaces of the workpiece may be bonded together using the CAPD. For example, distinct surfaces may be bonded to create a folded structure.

Alternatively, in other embodiments, at least two workpieces (at least a first and second workpiece) are bonded together with the CAPD wherein the CAPD is applied to the surface of a first workpiece (and optionally to the surface of at least a second workpiece; or optionally to both the first and second workpieces) and then a second workpiece is brought in contact with the CAPD on the surface of the first workpiece to bonded to the first and second workpieces together.

The application step (c) of the above process can be carried out by applying the waterborne CAPD composition of step (a) by conventional methods to the surfaces of the workpieces of step (b) to be bonded and/or joined. The applying step can be carried out, for example, by spraying, rolling, brushing, wiping, and mechanical printing methods such as gravure and curtain coating. The application step (c) of the present invention process is carried out at a temperature of from 1° C. to 100° C. in one embodiment; from 5° C. to 80° C. in still another embodiment, and from 15° C. to 50° C. in yet another embodiment. Above 100° C., it would be difficult to apply the adhesive because the water would evaporate too quickly. At 0° C. or below the aqueous medium may begin to freeze.

The drying step (g) of the present invention process is carried out at a temperature of from 1° C. to 150° C. in one embodiment; from 5° C. to 120° C. in still another embodiment, and from 10° C. to 80° C. in yet another embodiment. In a preferred embodiment, the waterborne CAPD composition is air dried at ambient temperature in step (g) of the above process. In other embodiments, the waterborne CAPD composition may be dried more rapidly using infrared lamps to flash water therefrom. If desired, the coated workpieces can optionally be pressed together in step (g) of the above process.

Optionally, the above processes can include a further step (h) of: pressing, or applying pressure to the adhesive bond. Optional step (h) may be performed for a pre-determined amount of time, for example from 1 s to 5 min during drying step (g), or for the entire duration of step (g).

The optional pressing step (h) of the present invention process, when used, may be carried out at a temperature of from 1° C. to 150° C. in one embodiment; from 5° C. to 120° C. in still another embodiment, and from 10° C. to 50° C. in yet another embodiment.

The pressure applied to the first and second workpieces together to contact the at least one layer of the waterborne CAPD composition of step (h) to form an adhesive bond depends upon the workpieces being bonded. For example, in bonding foam articles, pressures of 20 kPa to 35 kPa are typical. For example, in bonding Formica™ to particle board, pressures of at least 350 kPa psi are typically used. Generally, the pressure applied to workpieces to bond the workpieces together is from 10 kPa to 1,000 kPa in one embodiment. In some embodiments, only very light pressure may be applied, such as from 0.1 kPa to 10 kPa. After the pressing step (h) of the above adhesion process, an immediate, very permanent bond is formed.

After the initial bond with sufficient handling strength is formed, drying continues to take place and the bond strength increases until finally the ultimate bond strength is reached. This process may take anywhere from a few hours to several hours (e.g., 2 hr to 24 hr) at room temperature. This process time may be shortened by application of heat. When heat is employed, the ultimate strength may be obtained in as little as, for example, 30 min or less.

The waterborne CAPD composition is suitable for bonding a wide variety of substrates, including wood, fabric, paper, leather, artificial leather, plastic, plastic film, plastic foam, metal, concrete, rock, glass, ceramics, fiberglass, and the like. Examples of foam include polyurethane (PU) foam, polyethylene (PE) foam, latex rubber foam, and ethylene-vinyl acetate (EVA) foam.

One of the important advantages of the waterborne CAPD composition of the present invention is the waterborne CAPD composition's relatively long open time. For example, the waterborne CAPD composition is suitable as a contact adhesive upward of 30 min after the waterborne CAPD composition is applied and dried. This is important if the waterborne CAPD composition is not possible to contact the materials to be adhered immediately after the waterborne CAPD composition is applied and dried, as may occur in some large-scale operations.

Another advantage of the present invention process is that the steps of the process of the present invention described above can be carried out by conventional processes and equipment known to those skilled in handling adhesives.

In an embodiment, the CAPD is applied from a single container as a one-part (1-K) adhesive. In this embodiment, it is theorized that the application method and drying method provide shearing, evaporation of the aqueous medium, or evaporation of the base to promote the coagulation of the CAPD which provides tackiness and bond strength. In another embodiment, the CAPD may be co-applied with an electrolytic aqueous solution as a two-component (2-K) adhesive. In this embodiment, the electrolytic aqueous solution increases the coagulation of the CAPD to increase tackiness and bond strength. Co-application of the CAPD with the electrolytic aqueous solution may be conducted by co-spraying the electrolyte aqueous solution and the CAPD of the present invention from two separate containers on a substrate.

The electrolyte aqueous solution which can be used in the present invention is an aqueous solution of organic acid (salt) or inorganic acid (salt) having the properties of being able to coagulate the CAPD. The concentration of the electrolyte aqueous solution, which can be used in the present invention is at least 0.1 wt % in one general embodiment, at least 1.0 wt % in another embodiment, and at least 2.0 wt % in still another embodiment. Examples of electrolyte aqueous solution are aqueous solutions of inorganic salts such as sodium chloride, potassium chloride, lithium chloride, sodium bromide, potassium bromide, lithium bromide, potassium iodide, sodium iodide, potassium sulfate, sodium sulfate, ammonium sulfate, ammonium chloride, sodium nitrate, potassium nitrate, calcium chloride, ferrous sulfate, magnesium sulfate, zinc sulfate, copper sulfate, barium chloride, ferrous chloride, ferric chloride, magnesium chloride, ferric sulfate, aluminum sulfate, potassium alum and iron alum, aqueous solutions of inorganic acids such as hydrochloric acid, sulfuric acid, nitric acid and phosphoric acid, organic acids such as acetic acid, citric acid and formic acid and aqueous solutions thereof and aqueous solutions of organic salts such as sodium acetate, calcium acetate, sodium formate and calcium formate; and mixtures thereof.

The bonded workpieces, bonded with the waterborne CAPD composition of the present invention, forms a bonded article which exhibits several properties. For example, the bonded article has a high bond strength, and the bond strength is enough to resist failure of the adhesive bond before the bonded substrate (e.g., a conventional polyurethane foam) tears.

For example, the bond strength of the bonded article generally can be greater than or equal to (≥) 10 kPa in one embodiment, from 10 kPa to 500 kPa in another embodiment, and from 500 kPa to 2,000 kPa in still another embodiment.

In an embodiment, the bonded article substantially retains the flexibility of the original substrate(s) after bonding. This is in contrast to articles bonded with poly(chloroprene)-based adhesives which become stiffer than the original substrates due to the crystallinity of the poly(chloroprene). This effect is most apparent with flexible substrates such as foam, fabric, leather, and the like.

The bonded article of the present invention displays a heat resistant bond such that the bond does not fail from ambient temperature to 90° C. in one embodiment, or from ambient temperature to 80° C. in another embodiment; or from ambient temperature to 50° C. in still another embodiment.

The bonded article of the present invention also displays a creep resistant bond when bonded under tension (e.g., the tension generated by folding a foam substrate before bonding) such that the bond does not fail by creeping open within 48 hr in one embodiment, or within 24 hr in another embodiment, or within 1 hr in still another embodiment.

The waterborne CAPD composition of the present invention can be used in furniture, mattress, clothing, footwear, laminating, and construction applications.

The present invention will now be described in greater detail by way of the following specific Examples.

### EXAMPLES

The following Inventive Examples (Inv. Ex.) and Comparative Examples (Comp. Ex.) (collectively, “the Examples”) are presented herein to further illustrate the features of the present invention but are not intended to be construed, either explicitly or by implication, as limiting the scope of the claims. The Inventive Examples of the present invention are identified by Arabic numerals and the Comparative Examples are represented by letters of the alphabet. The following experiments analyze the performance of embodiments of compositions described herein. Unless otherwise stated all parts, concentrations, and percentages are by weight on a total weight basis.

### Raw Materials

Some of the raw materials (ingredients) used in the Examples are described in Table I.

TABLE I
Raw Materials

| | Brief Description | |
|---|---|---|
| Product | of Product | Supplier |
| INVISU ™ 3000 | Acrylic latex (pH | The Dow Chemical |
| | 4.75, 68% solids | Company (Dow) |
| | typical values) | |
| Benzoflex 2088 | Plasticizer | Eastman |
| Benzoflex 988 | Plasticizer | Eastman |
| SLL-FB | Surfactant (sodium | Stepan |
| | lauroyl lactylate) | |
| Capmul S12L | Surfactant (sodium | Abitec |
| | lauroyl lactylate) | |
| Geropon LG 3S | Surfactant (sodium | Solvay |
| | lauroyl glycinate) | |
| Geropon CG 3S | Surfactant (sodium | Solvay |
| | cocoyl glycinate) | |
| N-Oleoyl sarcosine | Surfactant | Sigma-Aldrich |
| N-Lauroyl sarcosine | Surfactant | Sigma-Aldrich |
| Aminosyl SLG | Surfactant (sodium | Jarchem |
| | lauroyl glutamate) | |
| 28% aqueous ammonia | 28 wt % solution | Fisher Scientific |
| | of ammonia in water | |
| Glycolic acid | Average Mn = 360 | Sigma- |
| ethoxylate lauryl | | Aldrich (#463221) |
| ether | | |
| Glycolic acid | Average Mn = 700 | Sigma- |
| ethoxylate oleyl | | Aldrich (#463280) |
| ether | | |
| TERGITOL ™15-S- | Non-ionic surfactant | Dow |
| 40 (70%) | (70 wt % aqueous | |
| | solution) | |
| Sodium stearoyl | Surfactant | Modernist Pantry |
| lactylate | | |
| Polystep A-16-22 | Surfactant (Sodium | Stepan |
| | dodecylbenzenesulfonate | |
| | 22% concentration in | |
| | water) | |

Surfactant pKaH

The pKaH for surfactants used in the Examples are listed in Table IL. Surfactant pKaH values were either collected from literature sources or measured according to the method described herein. The surfactant (1 g) was mixed with deionized water (60 g). Next, preparation steps were taken to convert all of the surfactants to their respective salt forms. Surfactants which are already in fully neutralized salt form (e.g., Geropon CG 3S, Geropon LG 3S, and Aminosyl SLG) were titrated “as is” (i.e., as received from the supplier). Surfactants in acid form were mixed with enough aqueous 0.5 M KOH (potassium hydroxide) to increase the solution pH to a pH of 10. Sodium lauroyl lactylate (Capmul S12L, 1 g) was mixed with 1.4 g TERGITOL™15-S-40 (70%), followed by enough aqueous 0.5 M KOH (potassium hydroxide) to increase the solution pH to a pH of 10. After the respective preparation steps above, the surfactant solutions were titrated with 0.5 M HCl to pH 2 while recording the pH and the amount of 0.5 M HCl added using a titrator, Mettler Toledo T70. Using standard acid-base titration procedures, the equivalence point representing the majority of the titratable species (the surfactant active ingredient) was identified, and the pKaH was determined as the pH of the surfactant at the mid-point between the equivalence point and the beginning of the titration of the major titratable species (the surfactant active ingredient).

In the case of the surfactant, N-oleoyl sarcosine, two equivalence points representing 43% and 57% of the titratable species were identified. The separate equivalent points indicate two different major titratable species with different pKaH, 6.0 and 6.6, respectively, as described in Table II.

TABLE II
Surfactant pKaH

| | Titratable | |
|---|---|---|
| | Proton Per | |
| | Active | |
| | Ingredient | |
| Surfactant | Conjugate Acid | pKaH |
| Geropon CG 3S | 1 | 6.6 |
| Geropon LG 3S | 1 | 6.3 |
| Aminosyl SLG | 2 | 4.8 |
| N-Oleoyl sarcosine | 1 | 6.0, 6.6 |
| N-Lauroyl sarcosine | 1 | 5.3 |
| Sodium lauroyl lactylate | 1 | 5.25 |
| n-octanoic acid* | 1 | 6.3-6.5 |
| Capric acid (C10)* | 1 | 7.1-7.3 |
| Lauric acid (C12)* | 1 | 7.5 |
| Myristic acid (C14)* | 1 | 8.1-8.2 |
| Palmitic acid (C16)* | 1 | 8.6-8.8 |
| Stearic acid (C18)^{†} | 1 | 10.15 |
| Oleic acid (C18:1 cis-9)^{†} | 1 | 9.85 |
| Glycolic acid ethoxylate lauryl ether (n = 4.5)^{‡} | 1 | 4.0 |
| Glycolic acid ethoxylate oleyl ether (n = 9)^{‡} | 1 | 3.68 |

Notes for Table II:
*pKaH data from Kanicky, J. R.; Poniatowski, A. F.; Mehta, N. R.; Shah, D. O. Langmuir 2000, 16, 172-177.
^{†}pKaH data from Kanicky, J. R.; Shah, D. O. J. Colloid. Interface Sci. 2002, 256, 201-207.
^{‡}pKaH data from Chiappisi, L.; Adv. Colloid Interface Sci. 2017, 250, 79-94.

### Calculation of Estimated Polymer Tg

The polymer Tg (degrees Kelvin) of a copolymer with Mn greater than 35,000 Da prepared from n monomer units may be estimated using the Fox equation as follows:

$$\frac{1}{Tg} = {\sum }_{i = 1}^{n} \frac{{w}_{i}}{{Tg}_{i}}$$

where wᵢ is the weight fraction of the i-th monomer unit in the polymer (not including any chain transfer agent or initiator residues) and Tgᵢ is the homopolymer Tg (Kelvin) of the i-th monomer unit in the polymer. The polymer Tg (Kelvin)=polymer Tg (° C.)+273.15° C.

The following “Polymer Tg” values in the Table III below may be used to calculate estimated polymer Tg values for the monomer units that are present in the first polymer and/or in the second polymer.

TABLE III

| Monomer Unit | Polymer Tg (° C.) |
|---|---|
| BA | −54 |
| MMA | 105 |
| AA | 105 |
| IA | 154 |
| STY | 100 |
| MAA | 228 |
| EHA | −65 |
| HEMA | 57 |
| HEA | −14 |
| DAAM | 77 |

### Dispersion Particle Size Distribution

Particle size distribution is measured with a CPS Disc Centrifuge Photosedimentometer 24000 (DCP) Particle Size Analyzer which employs the technique of differential centrifugal sedimentation within an optically clear spinning disc to measure the hydrodynamic radius (Rh) of particles.

### Dispersion pH

The dispersion pH is measured using a pH probe and meter with a digital readout. The pH meter is calibrated with standards at pH 4, pH 7, and pH 10 before use.

### Dispersion Viscosity

Dispersion viscosity is measured using a Brookfield Viscometer Model, and a Brookfield RV-DV-II-Pro viscometer spindle #3, at 25° C. after bringing the dispersion sample to 25° C. using a water bath. The sample is poured into a wide mouth cup and enough volume is poured in that when the viscometer apparatus is lowered, the spindle should be completely submerged into the dispersion. The viscometer is turned on and set to operate at a shear rate of 30 RPM. Readings are monitored for 15 min, or until the values stabilize, at which point, a final reading is recorded.

### Dispersion Solids

Dispersion solids content is measured by weighing about 1 g of dispersion on a weighed aluminum pan, recording this initial weight, heating the dispersion in the pan in an oven at 150° C. for 30 min, and re-weighing the sample for the final weight. The solids content is defined as follows:

$$Solids content = \frac{Pan + sample final weight - Empty pan weight}{Pan + sample initial weight - Empty pan weight}$$

### Calculation of Feed Rates

When a mixture is fed at a constant rate over a given time period, the feed rate in terms of weight per unit time is calculated as the total amount to be fed divided by the time period. Hence a monomer emulsion feed of 1,855 g at a constant rate over 120 min is fed at 15.46 g/min.

### Comparative Example A

The monomer composition of the polymer dispersion prepared in this Comp. Ex. A is as follows: 89.38 butyl acrylate (BA)/7.60 methyl methacrylate (MMA)/2.0 diacetone acrylamide (DAAM)/1.0 hydroxyethyl methacrylate (HEMA)/0.02 itaconic acid (IA).

Using a 5 L flask equipped with a mechanical stirrer, a charge of 362 g of deionized water is warmed to 83° C. Next, 12.9 g of 16.1% concentration ammonium persulfate in water is poured into the flask. Then, 2.8 g of 28% aqueous ammonia in water is added to the flask. Subsequently, 84 g of a polymer seed latex with a diameter of 60 nm at 29% concentration in water is poured into the flask.

Over a span of 120 min with a constant feed rate, a monomer emulsion feed made up of 0.24 g of itaconic acid, 1,233.7 g of butyl acrylate, 0.43 g of ammonium phosphate dibasic, 125.6 g of methyl methacrylate, 11.7 g of oleic acid, 13.8 g of hydroxyethyl methacrylate, 6.9 g of diacetone acrylamide, 460 g of deionized water, and 2.86 g of 28% aqueous ammonia, is gradually dispensed into the flask. From the outset of the emulsion feed, 105.71 g of an ammonium peroxodisulfate (1.96 wt % concentration) and ammonia (0.25 wt % concentration) solution is added at a constant rate over 120 min to form a reaction medium; and the reaction medium is maintained from 79° C. to 81° C. during the 120 min. After the 120 min feed period has elapsed, the reaction medium is maintained at 80° C. for 60 min; and then the reaction medium in the flask is cooled to 75° C.

When cooling of the reaction medium is started, a solution of iron (II) sulfate heptahydrate (0.013 g) and tetrasodium ethylenediaminetetraacetate (0.013 g) in 8.6 g of water is added to the flask; and the following two mixtures are fed to the flask: the first mixture (mix1) is 25.3 g of a solution of 4.4% concentration Bruggolite FF6M in water; and the second mixture (mix2) is 25.5 g of a 3.5% concentration aqueous solution of tert-butyl hydroperoxide. Mix1 is fed to the flask over the span of 40 min; and mix2 is fed to the flask over the span of 45 min. During the addition of these two mixtures (mix1 and mix2), the contents of the flask is cooled to 55° C. over the course of 45 min. Then, a 25.3 g suspension of ADH at 10% concentration in water is added to the contents of the flask. The polymer dispersion having a pH of 7.83 is obtained by the method described above in this Comp. Ex. A.

### Comparative Example B

In this Comp. Ex. B, the preparation of an adhesive formulation having less than a pH of 7.5 was attempted without success as follows:

The adhesive composition prepared in this Comp. Ex. B at pH 7.83, 100 g, was formulated with 4 g of 5% boric acid solution. The resultant polymer latex formulation coagulated into large sticky chunks, and the remaining liquid had a pH of 7.69. In this Comp. Ex. B, it was not possible to prepare a sprayable polymer latex formulation free of coagulum at a pH of less than 7.5 by addition of the boric acid solution to the adhesive formulation.

### Comparative Example C

The composition of Comp. Ex. A having a pH of 7.83 (100 parts) is blended with INVISU™ 3000 having a pH of 5 (12 parts) to form the resulting blend composition of this Comp. Ex. C. The resulting blend composition is free of coagulum at a pH of 6.95.

### Comparative Example D

The monomer composition of the polymer dispersion prepared in this Comp. Ex. D is as follows: 89.40 BA/9.60 MMA/1.0 HEMA.

Using a 5 L flask equipped with a mechanical stirrer, a charge of 580 g of deionized water is warmed to 83° C. Next, 6.92 g of ammonium persulfate and 3.80 g of sodium sulfate in water (43 g) is poured into the flask. Then, 1.52 g of 28% aqueous ammonia in water is added to the flask. Subsequently, 43.2 g of a polymer seed latex with diameter 235 nm at 21.8% concentration in water is poured into the flask, followed by 21.2 g of a polymer seed latex with diameter 100 nm at 11.1% concentration in water.

Over a span of 80 min with a constant feed rate, a monomer emulsion feed made up of 2,056.2 g of butyl acrylate, 0.71 g of anhydrous citric acid, 220.9 g of methyl methacrylate, 10.32 g of N-lauroyl sarcosine, 23.00 g of hydroxyethyl methacrylate, 320 g of deionized water, and 3.58 g of 28% aqueous ammonia, is gradually dispensed into the flask to form a reaction medium. From the outset of the emulsion feed, the reaction medium is maintained from 79° C. to 81° C. After 48% by weight of the monomer emulsion feed has been dispensed into the flask, a charge of 59.3 g of a polymer seed latex with diameter 60 nm at 29.9% concentration in water is added to the flask. After the 80 min feed period has elapsed, the reaction medium is maintained at 80° C. for 60 min, and then the reaction medium is cooled to 75° C.

When cooling of the reaction medium is started, a solution of iron (II) sulfate heptahydrate (0.022 g) and tetrasodium ethylenediaminetetraacetate (0.022 g) in 16 g of water is added to the reactor flask; and the following two mixtures are fed to the flask: the first mixture (mix1) is 50.2 g of a solution of 4.4% concentration Bruggolite FF6M in water and the second mixture (mix2) is 50.5 g of a 3.5% concentration aqueous solution of tert-butyl hydroperoxide. Mix1 is fed to the flask over the span of 40 min; and mix2 is fed to the flask over the span of 45 min. During the addition of these two mixtures (mix1 and mix2), the reaction medium is cooled to 55° C. over the course of 45 min. A polymer dispersion composition is obtained by the method described above in this Comp. Ex. D.

### Comparative Example E

In this Comp. Ex. E, a polymer dispersion is formulated to illustrate that the CAPD of the present invention is not prepared using the preparation method of this Comp. Ex. E. The preparation method used in this Comp. Ex. E is the same method as described in Inv. Ex. 1 except that no ADH is added. Therefore, a CAPD of the present invention is not prepared in this Comp. Ex. E because a crosslinker, component (II) in the present invention is not blended with a PPD, component (I) of the present invention.

### Comparative Example F

In this Comp. Ex. F, a monomer feed is prepared as described in Comp. Ex. A except that the following charges are used: 1,233.7 g of butyl acrylate, 0.43 g of ammonium phosphate dibasic, 125.6 g of methyl methacrylate, 11.7 g of octanoic acid, 13.8 g of hydroxyethyl methacrylate, 6.9 g of diacetone acrylamide, 460 g of deionized water, and 2.86 g of 28% aqueous ammonia. The charges are mixed in the same way as in Comp. Ex. A to create a monomer feed. In this feed the octanoic acid is neutralized with ammonia to form ammonium octanoate which functions as the surfactant. The monomers with low solubility in water (butyl acrylate and methyl methacrylate) cannot be emulsified in the monomer feed. Because the monomers cannot be emulsified, the composition containing ammonium octanoate would not form a stable polymer dispersion. The poor emulsification of monomers is due to the poor emulsifying ability of ammonium octanoate which is related to its short alkyl chain containing only 8 carbon atoms. Therefore, ammonium octanoate is not a suitable surfactant for preparing the waterborne PPD of the present invention.

### Comparative Example G

The monomer composition of the polymer dispersion prepared in this Comp. Ex. G is as follows: 96.3 BA/2.0 DAAM/1.7 MAA.

Using a 5 L flask equipped with a mechanical stirrer, a charge of 523 g of deionized water is warmed to 92° C. Then, 73.4 g of 8.6% concentration sodium bicarbonate in water is poured to the flask. Next, 11.3 g of 38.4% concentration ammonium persulfate in water is poured into the flask. Subsequently, 236.4 g of a polymer seed latex with a diameter of 40 nm at 30% concentration in water is poured into the flask.

Over a span of 91 min, a monomer emulsion feed made up of 1,637.1 g of butyl acrylate, 34 g of diacetone acrylamide, 85.9 g of a 22% concentration aqueous solution of sodium dodecylbenzenesulfonate, and 488.8 g of deionized water is gradually dispensed into the flask. At the outset, the feed rate of the monomer emulsion is 13.2 g/min for 10 min. From 10 min to 90 min, the feed rate of the monomer emulsion is 26.4 g/min. The reaction medium is maintained at 86° C. during the 91 min. After 56 min of the monomer feed has elapsed, 28.9 g of methacrylic acid and 8.5 g of water are added to the monomer emulsion with stirring to mix the methacrylic acid and water into the other components of the monomer emulsion. After the 91 min feed period has elapsed, the reaction medium is maintained at 86° C. for 15 min; and then the reaction medium in the flask is cooled to 75° C.

When the reaction medium is at 75° C., a solution of iron (II) sulfate heptahydrate (0.01 g) in 6.1 g of water is added to the flask; and the following two mixtures are fed to the flask: the first mixture (mix1) is 62.4 g of a solution of 9.0% concentration tert-butyl hydroperoxide in water; and the second mixture (mix2) is 59.2 g of a 8.8% concentration aqueous solution of sodium hydroxymethanesulfinic acid. Mix1 is fed to the flask over the span of 45 min; and mix2 is fed to the flask over the span of 45 min. During the addition of these two mixtures (mix1 and mix2), the contents of the flask is cooled to 50° C. over the course of 45 min. When the addition of mix1 and mix2 is complete, 25 g of water are added to the reaction flask. Then, a 98.3 g suspension of ADH at 10% concentration in water is added to the contents of the flask. The polymer dispersion having a pH of 5.71 is obtained by the method described above in this Comp. Ex. G.

### Comparative Example H

The monomer composition of the polymer dispersion prepared in this Comp. Ex. H is as follows: 98 BA/2.0 DAAM.

In this Comp. Ex. H, a polymer dispersion is prepared by the same method as in Comp. Ex. G, except for the following changes: the initial charge of sodium bicarbonate solution is 70.6 g of 4.9% concentration sodium bicarbonate in water; a monomer emulsion feed made up of 1,637.1 g of butyl acrylate, 34 g of diacetone acrylamide, 85.9 g of a 22% concentration aqueous solution of sodium dodecylbenzenesulfonate, and 488.8 g of deionized water is gradually dispensed into the flask to form a reaction medium, and no methacrylic acid is added. The polymer dispersion having a pH of 6.05 is obtained by the method described above in this Comp. Ex. H.

### Comparative Example I

In this Comp. Ex. I, a polymer dispersion is formulated to illustrate that the PPD and CAPD of the present invention are not prepared using the preparation method of this Comp. Ex. I. The preparation method used in this Comp. Ex. I is the same method as described in Inv. Ex. 10 except that 220 g of a 22% concentration aqueous solution of sodium dodecylbenzenesulfonate is added after the addition of mix1 and mix2 is complete such that the amount of sodium dodecylbenzenesulfonate in the dispersion is 2.05% on a dry weight basis. Therefore, the PPD and the CAPD of the present invention are not prepared in this Comp. Ex. I because an optional surfactant is present at greater than 2% on a dry weight basis.

### Comparative Example J

The monomer composition of the polymer dispersion prepared in this Comp. Ex. J is as follows: 53 BA/45.5 MMA/0.5 DAAM/1.0 HEMA.

In this Comp. Ex. J, a polymer dispersion is prepared by the same method as in Inv. Ex. 10, except that a monomer emulsion feed made up of 1,219.1 g of butyl acrylate, 1046.5 g of methyl methacrylate, 0.71 g of anhydrous citric acid, 11.50 g diacetone acrylamide, 16.79 g of Geropon LG 3S (sodium lauroyl glycinate at 20% concentration in water), 9.75 g of Capmul S12L (sodium lauroyl lactylate), 23.00 g of hydroxyethyl methacrylate, 280 g of deionized water, and 1.74 g of sodium bicarbonate, is gradually dispensed into the flask to form a reaction medium. The waterborne polymer dispersion composition is formulated in this Comp. Ex. J by addition of ADH (10% concentration in water) using the same method as described in Inv. Ex. 1.

### Comparative Example K

The monomer composition of the polymer dispersion prepared in this Comp. Ex. J is as follows: 88.89 BA/7.60 MMA/2.0 DAAM/1.0 HEMA/0.51 allyl methacrylate (ALMA).

In this Comp. Ex. K, a polymer dispersion is prepared by the same method as in Inv. Ex. 1, except that a monomer emulsion feed made up of 2,044.4 g of butyl acrylate, 0.71 g of anhydrous citric acid, 174.9 g of methyl methacrylate, 11.8 g of allyl methacrylate, 11.5 g diacetone acrylamide, 10.32 g of N-lauroyl sarcosine, 23.00 g of hydroxyethyl methacrylate, 320 g of deionized water, and 3.58 g of 28% aqueous ammonia, is gradually dispensed into the flask to form a reaction medium. The waterborne polymer dispersion composition is formulated in this Comp. Ex. K by addition of ADH (10% concentration in water) using the same method as described in Inv. Ex. 1.

### Example 1

The monomer composition of the waterborne PPD composition prepared in this Inv. Ex. 1 is as follows: 89.40 BA/9.10 MMA/0.5 DAAM/1.0 HEMA.

Using a 5 L flask equipped with a mechanical stirrer, a charge of 580 g of deionized water is warmed to 83° C. Next, 6.92 g of ammonium persulfate and 3.80 g of sodium sulfate in water (43 g) is poured into the flask. Then, 1.52 g of 28% aqueous ammonia in water is added to the flask. Subsequently, 43.2 g of a polymer seed latex with diameter 235 nm at 21.8% concentration in water is poured into the flask, followed by 21.2 g of a polymer seed latex with diameter 100 nm at 11.1% concentration in water.

Over a span of 80 min with a constant feed rate, a monomer emulsion feed made up of 2,056.2 g of butyl acrylate, 0.71 g of anhydrous citric acid, 209.4 g of methyl methacrylate, 11.5 g diacetone acrylamide, 10.32 g of N-lauroyl sarcosine, 23.00 g of hydroxyethyl methacrylate, 320 g of deionized water, and 3.58 g of 28% aqueous ammonia, is gradually dispensed into the flask to form a reaction medium. From the outset of the emulsion feed, the reaction medium is maintained from 79° C. to 81° C. After 48% by weight of the monomer emulsion feed has been dispensed into the flask, a charge of 59.3 g of a polymer seed latex with diameter 60 nm at 29.9% concentration in water is added to the flask. After the 80 min feed period has elapsed, the reaction medium is maintained at 80° C. for 60 min, and then the reaction medium is cooled to 75° C.

When cooling of the reaction medium is started, a solution of iron (II) sulfate heptahydrate (0.022 g) and tetrasodium ethylenediaminetetraacetate (0.022 g) in 16 g of water is added to the 5 L flask; and the following two mixtures are fed to the flask: the first mixture (mix1) is 50.2 g of a solution of 4.4% concentration Bruggolite FF6M in water and the second mixture (mix2) is 50.5 g of a 3.5% concentration aqueous solution of tert-butyl hydroperoxide. Mix1 is fed to the flask over the span of 40 min; and mix2 is fed to the flask over the span of 45 min. During the addition of these two mixtures (mix1 and mix2), the reaction medium is cooled to 55° C. over the course of 45 min to obtain the waterborne PPD composition. Then, 35.8 g suspension of ADH at 10% concentration in water is added to the PPD. A waterborne contact adhesive polymer dispersion composition is obtained by the method described above in this Inv. Ex. 1.

### Example 2

The monomer composition of the waterborne PPD composition prepared in this Inv. Ex. 2 is as follows: 89.40 BA/7.6 MMA/2.0 DAAM/1.0 HEMA.

In this Inv. Ex. 2, a waterborne PPD composition is prepared by the same method as in Inv. Ex. 1, except that a monomer emulsion feed made up of 2,056.2 g of butyl acrylate, 0.71 g of anhydrous citric acid, 174.9 g of methyl methacrylate, 46.0 g diacetone acrylamide, 6.1 g of N-lauroyl sarcosine, 4.2 g of N-oleoyl sarcosine, 23.00 g of hydroxyethyl methacrylate, 320 g of deionized water, and 3.58 g of 28% aqueous ammonia, is gradually dispensed into the flask to form a reaction medium.

A waterborne contact adhesive polymer dispersion composition is formulated in this Inv. Ex. 2 by addition of ADH (10% concentration in water) to the PPD using the same method as described in Inv. Ex. 1.

### Example 3

The monomer composition of the waterborne PPD composition prepared in this Inv. Ex. 3 is as follows: 89.40 BA/7.60 MMA/2.0 DAAM/1.0 HEMA.

Using a 5 L flask equipped with a mechanical stirrer, a charge composed of 580 g of deionized water is warmed to 83° C. Next, 17 g of 18.4% concentration ammonium persulfate in water is poured into the flask. Then, 0.91 g of 28% aqueous ammonia in water is added to the flask. Subsequently, 42 g of a polymer seed latex with diameter 60 nm at 23% concentration in water is poured into the flask.

Over a span of 80 min with a constant feed rate, a monomer emulsion feed made up of 1233.7 g of butyl acrylate, 0.43 g of anhydrous citric acid, 104.9 g of methyl methacrylate, 6.2 g of N-oleoyl sarcosine, 13.8 g of hydroxyethyl methacrylate, 27.6 g of diacetone acrylamide, 240 g of deionized water, and 1.69 g of 28% aqueous ammonia, is gradually dispensed into the flask to form a reaction medium. From the outset of the emulsion feed, 55.3 g of an ammonium peroxodisulfate (1.9% concentration) and ammonia (0.18% concentration) solution in water is added at a constant feed rate over a 80 min feed period while the reaction medium is maintained at a temperature of from 79° C. to 81° C. After the 80 min feed period has elapsed, the reaction medium is maintained at 80° C. for 60 min, and then the reaction medium is cooled to 75° C.

When cooling of the reaction medium is started, a solution of iron (II) sulfate heptahydrate (0.013 g) and tetrasodium ethylenediaminetetraacetate (0.013 g) in 10 g of water is added to the 5 L flask; and the following two mixtures are fed to the flask: the first mixture (mix1) is 25.3 g of a solution of 4.4% concentration Bruggolite FF6M in water and the second mixture (mix2) is 25.5 g of a 3.5% concentration aqueous solution of tert-butyl hydroperoxide. Mix1 is fed to the flask over the span of 40 min; and mix2 is fed to the flask over the span of 45 min. During the addition of these two mixtures (mix1 and mix2), the reaction medium is cooled to 55° C. over the course of 45 min to obtain the waterborne PPD composition. Then, a 24.3 g suspension of ADH at 10% concentration in water is added to the PPD. A waterborne contact adhesive polymer dispersion composition is obtained by the method described above in this Inv. Ex. 3.

### Example 4

In this Inv. Ex. 4, a waterborne contact adhesive polymer dispersion composition is formulated using the same method as described in Inv. Ex. 2 except that a plasticizer, described in Table IV, is added to the waterborne contact adhesive polymer dispersion composition.

### Examples 5 and 6

In these Inv. Ex. 5 and 6, waterborne contact adhesive polymer dispersion compositions are formulated using the same method as described in Inv. Ex. 1 except that a plasticizer, described in Table IV, is added to the waterborne contact adhesive polymer dispersion compositions.

### Example 7

The monomer composition of the waterborne PPD composition prepared in this Inv. Ex. 7 is as follows: 89.40 BA/9.10 MMA/0.5 DAAM/1.0 HEMA.

In this Inv. Ex. 7, a waterborne PPD composition is prepared by the same method as in Inv. Ex. 1, except that a monomer emulsion feed made up 2,056.2 g of butyl acrylate, 0.71 g of anhydrous citric acid, 209.4 g of methyl methacrylate, 11.5 g diacetone acrylamide, 55.95 g of Geropon LG 3S (sodium lauroyl glycinate at 20% concentration in water), 23.00 g of hydroxyethyl methacrylate, 320 g of deionized water, and 1.26 g of 28% aqueous ammonia which is gradually dispensed into the flask to form a reaction medium.

A waterborne contact adhesive polymer dispersion composition is formulated in this Inv. Ex. 7 by addition of ADH (10% concentration in water) to the PPD using the same method as described in Inv. Ex. 1.

### Example 8

The monomer composition of the waterborne PPD composition prepared in this Inv. Ex. 8 is as follows: 89.40 BA/7.60 MMA/2.0 DAAM/1.0 HEMA.

In this Inv. Ex. 8, a waterborne PPD composition is prepared by the same method as in Inv. Ex. 1, except that a monomer emulsion feed made up 2,056.2 g of butyl acrylate, 0.71 g of anhydrous citric acid, 179.4 g of methyl methacrylate, 46.00 g diacetone acrylamide, 13.93 g of Stepan SLL-FB (sodium lauroyl lactylate), 23.00 g of hydroxyethyl methacrylate, 320 g of deionized water, and 3.58 g of 28% aqueous ammonia, is gradually dispensed into the flask to form a reaction medium.

A waterborne contact adhesive polymer dispersion composition is formulated in this Inv. Ex. 8 by addition of ADH (10% concentration in water) to the PPD using the same method as described in Inv. Ex. 1.

### Example 9

The monomer composition of the waterborne PPD composition prepared in this Inv. Ex. 9 is as follows: 89.40 BA/7.60 MMA/2.0 DAAM/1.0 HEMA.

In this Inv. Ex. 9, a waterborne PPD composition is prepared by the same method as in Inv. Ex. 1, except that a monomer emulsion feed made up of 2,056.2 g of butyl acrylate, 0.71 g of anhydrous citric acid, 179.4 g of methyl methacrylate, 46.00 g diacetone acrylamide, 16.79 g of Geropon LG 3S (sodium lauroyl glycinate at 20% concentration in water), 9.75 g of Stepan SLL-FB (sodium lauroyl lactylate), 23.00 g of hydroxyethyl methacrylate, 320 g of deionized water, and 3.58 g of 28% aqueous ammonia, is gradually dispensed into the flask to form a reaction medium.

A waterborne contact adhesive polymer dispersion composition is formulated in this Inv. Ex. 9 by addition of ADH (10% concentration in water) to the PPD using the same method as described in Inv. Ex. 1.

### Example 10

The monomer composition of the waterborne PPD composition prepared in this Inv. Ex. 10 is as follows: 97 BA/2.0 DAAM/1.0 HEMA.

In this Inv. Ex. 10, a waterborne PPD composition is prepared by the same method as in Inv. Ex. 1, except that 6.92 g of sodium persulfate is used in place of ammonium persulfate in the initial charge to the flask and except that 1.50 g of 50 wt % sodium hydroxide in water is added to the flask in place of aqueous ammonia. Also, in this Inv. Ex. 10, a monomer emulsion feed made up of 2,231.1 g of butyl acrylate, 0.71 g of anhydrous citric acid, 46.00 g diacetone acrylamide, 16.79 g of Geropon LG 3S (sodium lauroyl glycinate at 20% concentration in water), 9.75 g of Capmul S12L (sodium lauroyl lactylate), 23.00 g of hydroxyethyl methacrylate, 320 g of deionized water, and 1.74 g of sodium bicarbonate, is gradually dispensed into the flask to form a reaction medium.

A waterborne contact adhesive polymer dispersion composition is formulated in this Inv. Ex. 10 by addition of ADH (10% concentration in water) to the PPD using the same method as described in Inv. Ex. 1.

### Example 11

The monomer composition of the waterborne PPD composition prepared in this Inv. Ex. 11 is as follows: 97 BA/2.0 DAAM/1.0 HEMA.

In this Inv. Ex. 11, a waterborne PPD composition is prepared by the same method as in Inv. Ex. 1, except that a monomer emulsion feed made up of 2,231.1 g of butyl acrylate, 0.71 g of anhydrous citric acid, 46.00 g diacetone acrylamide, 55.95 g of Geropon CG 3S (sodium cocoyl glycinate at 20% concentration in water), 23.00 g of hydroxyethyl methacrylate, 320 g of deionized water, and 1.26 g of 28% aqueous ammonia, is gradually dispensed into the flask to form the reaction medium.

A waterborne contact adhesive polymer dispersion composition is formulated in this Inv. Ex. 11 by addition of ADH (10% concentration in water) to the PPD using the same method as described in Inv. Ex. 1.

### Example 12

The monomer composition of the waterborne PPD composition prepared in this Inv. Ex. 12 is as follows: 97 BA/2.0 DAAM/1.0 HEMA.

In this Inv. Ex. 12, a waterborne PPD composition is prepared by the same method as in Inv. Ex. 1, except that a monomer emulsion feed made up of 2,231.1 g of butyl acrylate, 0.71 g of anhydrous citric acid, 46.00 g diacetone acrylamide, 11.19 g of glycolic acid ethoxylate lauryl ether, 23.00 g of hydroxyethyl methacrylate, 320 g of deionized water, and 4.35 g of sodium bicarbonate, is gradually dispensed into the flask to form a reaction medium.

A waterborne contact adhesive polymer dispersion composition is formulated in this Inv. Ex. 12 by addition of ADH (10% concentration in water) to the PPD using the same method as described in Inv. Ex. 1.

### Example 13

The monomer composition of the waterborne PPD composition prepared in this Inv. Ex. 13 is as follows: 97 BA/2.0 DAAM/1.0 HEMA.

In this Inv. Ex. 13, a waterborne PPD composition is prepared by the same method as in Inv. Ex. 1, except that a monomer emulsion feed made up of 2,231.1 g of butyl acrylate, 0.71 g of anhydrous citric acid, 46.00 g diacetone acrylamide, 11.19 g of glycolic acid ethoxylate lauryl ether, 23.00 g of hydroxyethyl methacrylate, 320 g of deionized water, and 3.08 g of sodium bicarbonate, is gradually dispensed into the flask to form a reaction medium.

A waterborne contact adhesive polymer dispersion composition is formulated in this Inv. Ex. 13 by addition of 10% concentration ADH to the PPD using the same method as described in Inv. Ex. 1.

### Example 14

In this Inv. Ex. 14, a waterborne contact adhesive polymer dispersion composition is formulated using the same method as described in Inv. Ex.1 except that a total of 107.5 g of ADH at 10% concentration in water is added to the PPD.

### Example 15

The monomer composition of the waterborne PPD composition prepared in this Inv. Ex. 15 is as follows: 89.40 BA/7.60 MMA/2.0 DAAM/1.0 HEMA.

In this Inv. Ex. 15, a waterborne PPD composition is prepared by the same method as in Inv. Ex. 1, except that a monomer emulsion feed made up of 2,056.2 g of butyl acrylate, 1.42 g of anhydrous citric acid, 179.4 g of methyl methacrylate, 46.00 g diacetone acrylamide, 33.57 g of Geropon LG 3S (sodium lauroyl glycinate at 20% concentration in water), 97.50 g of Stepan SLL-FB (sodium lauroyl lactylate) at 20% concentration in water, 23.00 g of hydroxyethyl methacrylate, 320 g of deionized water, and 1.79 g of 28% aqueous ammonia, is gradually dispensed into the flask to form a reaction medium.

A waterborne contact adhesive polymer dispersion composition is formulated in this Inv. Ex. 15 by addition of 10% concentration ADH to the PPD using the same method as described in Inv. Ex. 1.

### Example 16

The monomer composition of the waterborne PPD composition prepared in this Inv. Ex. 16 is as follows: 68 EHA (2-ethylhexyl acrylate)/20 BA/6.75 MMA/2.0 DAAM/2.0 STY (styrene)/1.0 HEA (2-hydroxyethyl acrylate)/0.25 MAA (methacrylic acid).

In this Inv. Ex. 16, a waterborne PPD composition is prepared by the same method as in Inv. Ex. 1, except that a monomer emulsion feed made up of 1,565.0 g of 2-ethylhexyl acrylate, 460.0 g of butyl acrylate, 155.3 g of methyl methacrylate, 0.71 g of anhydrous citric acid, 46.00 g diacetone acrylamide, 19.84 g of Geropon LG 3S (sodium lauroyl glycinate at 20% concentration in water), 11.52 g of Stepan SLL-FB (sodium lauroyl lactylate), 23.00 g of 2-hydroxyethyl acrylate, 46.00 g of styrene, 320 g of deionized water, 5.75 g of methacrylic acid, and 5.32 g of 28% aqueous ammonia, is gradually dispensed into the flask to form a reaction medium.

A waterborne contact adhesive polymer dispersion composition is formulated in this Inv. Ex. 16 by addition of 10% concentration ADH to the PPD using the same method as described in Inv. Ex. 1, followed by blending with 20 g of INVISU™3000 per 100 g of waterborne PPD composition.

### Example 17

The monomer composition of the waterborne PPD composition prepared in this Inv. Ex. 17 is as follows: 96.75 BA/2.0 DAAM/1.0 HEMA/0.25 MAA.

In this Inv. Ex. 17, a waterborne PPD composition is prepared by the same method as in Inv. Ex. 1, except that a monomer emulsion feed made up of 2,225.4 g of butyl acrylate, 0.71 g of anhydrous citric acid, 46.00 g diacetone acrylamide, 16.79 g of Geropon LG 3S (sodium lauroyl glycinate at 20% concentration in water), 9.75 g of Stepan SLL-FB (sodium lauroyl lactylate), 23.00 g of 2-hydroxyethyl methacrylate, 320 g of deionized water, 5.75 g of methacrylic acid, and 5.32 g of 28% aqueous ammonia, is gradually dispensed into the flask to form a reaction medium.

A waterborne contact adhesive polymer dispersion composition is formulated in this Inv. Ex. 17 by addition of 10% concentration ADH to the PPD using the same method as described in Inv. Ex. 1, followed by blending with 20 g of INVISU™3000 per 100 g of waterborne PPD composition.

### Example 18

The monomer composition of the waterborne PPD composition prepared in this Inv. Ex. 18 is as follows: 68 EHA/20 BA/7.0 MMA/2.0 DAAM/2.0 STY/1.0 HEA.

In this Inv. Ex. 18, a waterborne PPD composition is prepared by the same method as in Inv. Ex. 1, except that a monomer emulsion feed made up of 1,565.0 g of 2-ethylhexyl acrylate, 460.0 g of butyl acrylate, 161.0 g of methyl methacrylate, 0.71 g of anhydrous citric acid, 46.00 g diacetone acrylamide, 16.79 g of Geropon LG 3S (sodium lauroyl glycinate at 20% concentration in water), 9.75 g of Stepan SLL-FB (sodium lauroyl lactylate), 23.00 g of 2-hydroxyethyl acrylate, 46.00 g of styrene, 320 g of deionized water, and 5.32 g of 28% aqueous ammonia, is gradually dispensed into the flask to form a reaction medium.

A waterborne contact adhesive polymer dispersion composition is formulated in this Inv. Ex. 18 by addition of 10% concentration ADH to the PPD using the same method as described in Inv. Ex. 1.

### Example 19

The monomer composition of the waterborne PPD composition prepared in this Inv. Ex. 19 is as follows: 97 BA/2.0 DAAM/1.0 HEMA.

In this Inv. Ex. 19, a waterborne PPD composition is prepared by the same method as in Inv. Ex. 1, except that a monomer emulsion feed made up of 2,231.1 g of butyl acrylate, 0.71 g of anhydrous citric acid, 46.00 g diacetone acrylamide, 14.14 g of Aminosyl SLG (sodium lauroyl glutamate), 23.00 g of 2-hydroxyethyl methacrylate, 320 g of deionized water, and 1.26 g of 28% aqueous ammonia, is gradually dispensed into the flask to form a reaction medium.

A waterborne contact adhesive polymer dispersion composition is formulated in this Inv. Ex. 19 by addition of 10% concentration ADH to the PPD using the same method as described in Inv. Ex. 9.

### Example 20

The monomer composition of the waterborne PPD composition prepared in this Inv. Ex. 20 is as follows: 98 BA/2.0 DAAM.

In this Inv. Ex. 20, a waterborne PPD composition is prepared by the same method as in Inv. Ex. 1, except that a monomer emulsion feed made up of 2,254.0 g of butyl acrylate, 0.71 g of anhydrous citric acid, 46.00 g diacetone acrylamide, 16.79 g of Geropon LG 3S (sodium lauroyl glycinate at 20% concentration in water), 9.75 g of Stepan SLL-FB (sodium lauroyl lactylate), 320 g of deionized water, and 1.26 g of 28% aqueous ammonia, is gradually dispensed into the flask to form a reaction medium.

A waterborne contact adhesive polymer dispersion composition is formulated in this Inv. Ex. 20 by addition of 10% concentration ADH to the PPD using the same method as described in Inv. Ex. 1.

### Example 21

The monomer composition of the waterborne PPD composition prepared in this Inv. Ex. 21 is as follows: 98 BA/2.0 DAAM.

In this Inv. Ex. 21, a waterborne PPD composition is prepared by the same method as in Inv. Ex. 1, except that a monomer emulsion feed made up of 2,185.9 g of butyl acrylate, 0.71 g of anhydrous citric acid, 46.00 g diacetone acrylamide, 16.79 g of Geropon LG 3S (sodium lauroyl glycinate at 20% concentration in water), 9.75 g of Stepan SLL-FB (sodium lauroyl lactylate), 23.00 g of 2-hydroxyethyl methacrylate, 46.00 g of styrene, 320 g of deionized water, and 1.26 g of 28% aqueous ammonia, is gradually dispensed into the flask to form a reaction medium.

A waterborne contact adhesive polymer dispersion composition is formulated in this Inv. Ex. 21 by addition of 10% concentration ADH to the PPD using the same method as described in Inv. Ex. 1.

### Example 22

The monomer composition of the waterborne PPD composition prepared in this Inv. Ex. 22 is as follows: 97 BA/1.0 HEMA/2.0 DAAM.

Using a 5 L flask equipped with a mechanical stirrer, a charge of 580 g of deionized water is warmed to 83° C. Next, 5.54 g of sodium persulfate and 3.80 g of sodium sulfate in water (38 g) is poured into the flask. Then, 1.50 g of 50% aqueous sodium hydroxide in water is added to the flask. Subsequently, 43.2 g of a polymer seed latex with diameter 235 nm at 21.8% concentration in water is poured into the flask, followed by 21.2 g of a polymer seed latex with diameter 100 nm at 11.1% concentration in water.

Over a span of 120 min with a constant feed rate, a monomer emulsion feed made up of 2,231.1 g of butyl acrylate, 0.71 g of anhydrous citric acid, 46.0 g diacetone acrylamide, 6.56 g of N-lauroyl sarcosine, 11.13 g of sodium stearoyl lactylate, 23.00 g of hydroxyethyl methacrylate, 280 g of deionized water, and 3.77 g of sodium bicarbonate, is gradually dispensed into the flask to form a reaction medium. From the outset of the emulsion feed, 35.9 g of a sodium peroxodisulfate (3.9% concentration) solution in water is added at a constant feed rate over a 120 min feed period the reaction medium is maintained from 79° C. to 81° C. After 48% by weight of the monomer emulsion feed has been dispensed into the flask, a charge of 59.3 g of a polymer seed latex with diameter 60 nm at 29.9% concentration in water is added to the flask. After the 120 min feed period has elapsed, the reaction medium is maintained at 80° C. for 60 min, and then the reaction medium is cooled to 75° C.

When cooling of the reaction medium is started, a solution of iron (II) sulfate heptahydrate (0.022 g) and tetrasodium ethylenediaminetetraacetate (0.022 g) in 16 g of water is added to the 5 L flask; and the following two mixtures are fed to the flask: the first mixture (mix1) is 50.2 g of a solution of 4.4% concentration Bruggolite FF6M in water and the second mixture (mix2) is 50.5 g of a 3.5% concentration aqueous solution of tert-butyl hydroperoxide. Mix1 is fed to the flask over the span of 45 min; and mix2 is fed to the flask over the span of 45 min. During the addition of these two mixtures (mix1 and mix2), the reaction medium is cooled to 55° C. over the course of 45 min to obtain the waterborne PPD composition. Then, 35.8 g suspension of ADH at 10% concentration in water is added to the PPD. A waterborne contact adhesive polymer dispersion composition is obtained by the method described above in this Inv. Ex. 22.

### Example 23

The monomer composition of the waterborne PPD composition prepared in this Inv. Ex. 23 is as follows: 68 BA/30.5 MMA/0.5 DAAM/1.0 HEMA.

In this Inv. Ex. 23, a waterborne PPD composition is prepared by the same method as in Inv. Ex. 10, except that a monomer emulsion feed made up of 1,564.1 g of butyl acrylate, 701.5 g of methyl methacrylate, 0.71 g of anhydrous citric acid, 11.50 g diacetone acrylamide, 16.79 g of Geropon LG 3S (sodium lauroyl glycinate at 20% concentration in water), 9.75 g of Capmul S12L (sodium lauroyl lactylate), 23.00 g of hydroxyethyl methacrylate, 280 g of deionized water, and 1.74 g of sodium bicarbonate, is gradually dispensed into the flask to form a reaction medium. A waterborne contact adhesive polymer dispersion composition is formulated in this Inv. Ex. 23 by addition of 10% concentration ADH to the PPD using the same method as described in Inv. Ex. 1.

TABLE IV
Comparative Polymer Dispersion and CAPD Formulations

| | | Calculated | Dispersion | | | INVISU ™ | ADH | |
|---|---|---|---|---|---|---|---|---|
| | Contact Adhesive Polymer | Polymer | or PPD | | Plasticizer | 3000 | Solution | |
| | Composition Based on Monomers | Tg | Weight | | Weight | Weight | Weight | |
| Example No. | (wt %) | (° C.) | (g) | Plasticizer | (g) | (g) | (g) | pH |
| Comp. Ex. A | 89.38 BA/7.60 MMA/2.0 | −44 | 100 | — | — | — | 1 | 7.83 |
| | DAAM/1.0 HEMA/0.02 IA | | | | | | | |
| Comp. Ex. C | 89.38 BA/7.60 MMA/2.0 | −44 | 100 | — | — | 12 | 1 | 6.95 |
| | DAAM/1.0 HEMA/0.02 IA | | | | | | | |
| Comp. Ex. D | 89.40 BA/9.60 MMA/1.0 HEMA | −44 | 100 | — | — | — | 1 | 6.33 |
| Comp. Ex. E* | 89.40 BA/9.10 MMA/0.5 | −44 | 100 | — | — | — | 0 | 5.30 |
| | DAAM/1.0 HEMA | | | | | | | |
| Comp. Ex. G | 96.3 BA/2.0 DAAM/1.7 MAA | −50 | 100 | — | — | — | 3 | 5.71 |
| Comp. Ex. H | 98.0 BA/2.0 DAAM | −52 | 100 | | | | 3 | 6.05 |
| Comp. Ex. I | 97.0 BA /2.0 DAAM/1.0 HEMA | −52 | 100 | | | | 1 | 6.26 |
| Comp. Ex. J | 53.0 BA/45.5 MMA/0.5 DAAM/1.0 | 0 | 100 | | | | 1 | 6.15 |
| | HEMA | | | | | | | |
| Comp. Ex. K | 88.89 BA/7.60 MMA/2.0 | −44 | 100 | — | — | — | 1 | 6.20 |
| | DAAM/1.0 HEMA/0.51 ALMA | | | | | | | |
| Inv. Ex. 1 | 89.40 BA/9.10 MMA/0.5 | −44 | 100 | — | — | — | 1 | 5.44 |
| | DAAM/1.0 HEMA | | | | | | | |
| Inv. Ex. 2 | 89.40 BA/7.60 MMA/2.0 | −44 | 100 | — | — | — | 1 | 6.49 |
| | DAAM/1.0 HEMA | | | | | | | |
| Inv. Ex. 3 | 89.40 BA/7.60 MMA/2.0 | −44 | 100 | — | — | — | 1 | 6.62 |
| | DAAM/1.0 HEMA | | | | | | | |
| Inv. Ex. 4 | 89.40 BA/7.60 MMA/2.0 | −44 | 100 | Benzoflex | 7 | — | 1 | 6.21 |
| | DAAM/1.0 HEMA | | | 988 | | | | |
| Inv. Ex. 5 | 89.40 BA/9.10 MMA/0.5 | −44 | 100 | Benzoflex | 4 | — | 1 | 6.33 |
| | DAAM/1.0 HEMA | | | 2088 | | | | |
| Inv. Ex. 6 | 89.40 BA/9.10 MMA/0.5 | −44 | 100 | Benzoflex | 4 | — | 1 | 7.20 |
| | DAAM/1.0 HEMA | | | 2088 | | | | |
| Inv. Ex. 7 | 89.40 BA/9.10 MMA/0.5 | −44 | 100 | — | — | — | 1 | 6.40 |
| | DAAM/1.0 HEMA | | | | | | | |
| Inv. Ex. 8 | 89.40 BA/7.60 MMA/2.0 | −44 | 100 | — | — | — | 1 | 6.40 |
| | DAAM/1.0 HEMA | | | | | | | |
| Inv. Ex. 9 | 89.40 BA/7.60 MMA/2.0 | −44 | 100 | — | — | — | 1 | 6.40 |
| | DAAM/1.0 HEMA | | | | | | | |
| Inv. Ex. 10 | 97.0 BA /2.0 DAAM/1.0 HEMA | −52 | 100 | — | — | — | 1 | 6.26 |
| Inv. Ex. 11 | 97.0 BA/2.0 DAAM/1.0 HEMA | −52 | 100 | — | — | — | 1 | 6.63 |
| Inv. Ex. 12 | 97.0 BA/2.0 DAAM/1.0 HEMA | −52 | 100 | — | — | — | 1 | 6.53 |
| Inv. Ex. 13 | 97.0 BA/2.0 DAAM/1.0 HEMA | −52 | 100 | — | — | — | 1 | 5.88 |
| Inv. Ex. 14 | 89.40 BA/7.60 MMA/2.0 | −44 | 100 | — | — | — | 3 | 6.40 |
| | DAAM/1.0 HEMA | | | | | | | |
| Inv. Ex. 15 | 89.40 BA/7.60 MMA/2.0 | −44 | 100 | — | — | — | 1 | 6.80 |
| | DAAM/1.0 HEMA | | | | | | | |
| Inv. Ex. 16 | 68 EHA/20 BA/6.75 MMA/2.0 | −52 | 100 | — | — | 20 | 1 | 6.70 |
| | DAAM/2.0 STY/1.0 HEA/0.25 | | | | | | | |
| | MAA | | | | | | | |
| Inv. Ex. 17 | 96.75 BA/2.0 DAAM/1.0 | −52 | 100 | — | — | 20 | 1 | 7.00 |
| | HEMA/0.25 MAA | | | | | | | |
| Inv. Ex. 18 | 68 EHA/20 BA/7.0 MMA/2.0 | −52 | 100 | — | — | — | 1 | 6.48 |
| | DAAM/2.0 STY/1.0 HEA | | | | | | | |
| Inv. Ex. 19 | 97.0 BA/2.0 DAAM/1.0 HEMA | −52 | 100 | — | — | — | 1 | 5.80 |
| Inv. Ex. 20 | 98.0 BA/2.0 DAAM | −52 | 100 | — | — | — | 1 | 6.00 |
| Inv. Ex. 21 | 95.0 BA/2.0 DAAM/2.0 STY/1.0 | −50 | 100 | — | — | — | 1 | 6.00 |
| | HEMA | | | | | | | |
| Inv. Ex. 22 | 97.0 BA/2.0 DAAM/1.0 HEMA | −52 | 100 | — | — | — | 1 | 6.20 |
| Inv. Ex. 23 | 68 BA/30.5 MMA/0.5 DAAM/1.0 | −20 | 100 | — | — | — | 1 | 6.10 |
| | HEMA | | | | | | | |

Notes for Table IV:
* In Comp. Ex. E, a crosslinker was not added to a PPD. Therefore, the CAPD of the present invention was not formed in Comp. Ex. E.

### Testing Methods

### Adhesion Test

The adhesion test herein refers to forming a foam-to-foam bond after application of an adhesive composition. Samples of cubes or blocks of substrates made of foam are used to test the adhesion strength of the contact adhesive compositions of the Examples. Samples of 2.54 cm thick high density 100% polyurethane foam (Airtex, Ellsworth, Wisconsin) were cut into blocks and used as a substrate for testing. The dimensions of the sample blocks were: 3 cm long×3 cm wide×2.54 cm thick. The adhesive was applied to the 3 cm by 3 cm face of the blocks.

A contact adhesive composition was sprayed onto the blocks using a gravity feed Simalfa Primus spray gun. The top face of one first block was sprayed with 300-450 grams per square meter of the adhesive composition at room temperature. Any clogging or blocking at the spray nozzle was noted, and a subjective assessment regarding sprayability was made. The sprayed face of the first block was placed on the unsprayed face of a second block immediately after spraying, and the two blocks were pressed together by hand for 10 s. Then the adhesion of the foam-to-foam bond of the two blocks was tested as follows:

### Fast-Set/Instant Tack

Immediately after pressing the first and second foam blocks together, the foam blocks are pulled apart using finger-tip force. If the adhesive resists the force, it is qualitatively assessed as tacky with fast-set (referred to as a “YES” in Tables VI and VII). If the adhesive does not noticeably resist debonding, it is qualitatively assessed as non-tacky (referred to as a “NO” in Table VI).

### Adhesion at 15 Minutes After Application of Adhesive

At 15 min after spraying the adhesive onto the first cube and pressing the two cubes together, the two blocks are grasped at the block edges by the fingers of the two hands of an individual and peeled apart by the individual. The failure mode of the two cubes is observed. A description of the various failure modes used in this test are as follows:

### Failure Modes

“AF” stands for “Adhesive Failure”. AF occurs when the blocks peel apart and adhesive is visibly observed with the naked eye on both blocks.

“CF” stands for “Cohesive Failure”. CF occurs when the blocks peel apart and adhesive is visibly observed with the naked eye on one block.

“FT” stands for “Foam Tear(s)”. FT occurs when tear(s) are visibly observed with the naked eye on all or part of the bonded surface of the blocks or within the bulk of the foam.

### Adhesion at 60 Minutes After Application of Adhesive

At 60 min after spraying the adhesive onto the first cube and pressing the two cubes together, the two blocks are grasped at the block edges by the fingers of the two hands of an individual and peeled apart by the individual. The failure mode of the two cubes is observed. The failure modes described above are also used in this test.

### Results of Testing

The contact adhesive composition prepared in the Examples were tested in accordance with the tests described above; and the results of such testing are described in Table VI and Table VII.

TABLE VI
Property/Performance of Contact Adhesives

| | Comp. | Comp. | Comp. | Inv. | Inv. | Inv. | Inv. | Inv. | Inv. | Inv. | Inv. | Inv. |
|---|---|---|---|---|---|---|---|---|---|---|---|---|
| Property Tested | Ex. C | Ex. D | Ex. E | Ex. 1 | Ex. 2 | Ex. 3 | Ex. 4 | Ex. 5 | Ex. 6 | Ex. 7 | Ex. 8 | Ex. 9 |
| Sprayability | NO | YES | YES | YES | YES | YES | YES | YES | YES | YES | YES | YES |
| Fast-set/Instant tack | n/a* | YES | NO | YES | YES | YES | YES | YES | YES | YES | YES | YES |
| Adhesion @ 15 min | n/a | AF | AF | FT | CF | AF | CF | FT | CF | FT | FT | FT |
| after application | | | | | | | | | | | | |
| Adhesion @60 min | n/a | AF | AF | FT | FT | FT | FT | FT | FT | FT | FT | FT |
| after application | | | | | | | | | | | | |

*“n/a” means “not applicable”

TABLE VII
Property/Performance of Contact Adhesives

| Property | Inv. | Inv. | Inv. | Inv. | Inv. | Inv. | Inv. | Inv. | Inv. | Inv. | Inv. | Inv. |
|---|---|---|---|---|---|---|---|---|---|---|---|---|
| Tested | Ex. 10 | Ex. 11 | Ex. 12 | Ex. 13 | Ex. 14 | Ex. 15 | Ex. 16 | Ex. 17 | Ex. 18 | Ex. 19 | Ex. 20 | Ex. 21 |
| Sprayability | YES | YES | YES | YES | YES | YES | YES | YES | YES | YES | YES | YES |
| Instant tack | YES | YES | YES | YES | YES | YES | YES | YES | YES | YES | YES | YES |
| Adhesion @15 | FT | FT | FT | FT | FT | CF | FT | CF | CF | CF | FT | FT |
| min after | | | | | | | | | | | | |
| application | | | | | | | | | | | | |
| Adhesion @60 | FT | FT | FT | FT | FT | FT | FT | FT | FT | FT | FT | FT |
| min after | | | | | | | | | | | | |
| application | | | | | | | | | | | | |

* “n/a” means “not applicable”

TABLE VIII
Property/Performance of Contact Adhesives

| Property | Comp. | Comp. | Comp. | Comp. | Comp. | Inv. | Inv. |
|---|---|---|---|---|---|---|---|
| Tested | Ex. G | Ex. H | Ex. I | Ex. J | Ex. K | Ex. 22 | Ex. 23 |
| Sprayability | YES | YES | YES | YES | YES | YES | YES |
| Instant tack | YES | YES | NO | NO | NO | YES | YES |
| Adhesion @15 | AF | AF | AF | AF | AF | FT | AF |
| min after | | | | | | | |
| application | | | | | | | |
| Adhesion @60 | AF | AF | AF | AF | AF | FT | FT |
| min after | | | | | | | |
| application | | | | | | | |

* “n/a” means “not applicable”

### Discussion of Results

In Comp. Ex. C, the pH of the polymer dispersion stabilized by ammonium oleate surfactant is decreased below at pH 7.5 (pH 6.95). However, the polymer dispersion obtained in Comp. Ex. C is not sprayable. Therefore, one skilled in the art might expect that a fast-setting waterborne contact adhesive polymer dispersion at less than a pH of 7.5 would not be sprayable. Surprisingly, the waterborne contact adhesive polymer dispersions of Inv. Ex. 1-21 which comprise surfactants of component (D) are sprayable.

Furthermore, although the polymer dispersion of Comp. Ex. D is sprayable and formulated at pH 6.33, the polymer dispersion of Comp. Ex. D lacks component (B); and therefore, the polymer dispersion of Comp. Ex. D does not form bonds, within 60 minutes, strong enough to resist failure of the adhesive bond before the bonded foam tears (foam tear bonding).

Similarly, the polymer dispersion of Comp. Ex. E is sprayable and formulated at pH 5.30. However, the polymer dispersion of Comp. Ex. E lacks component (II); and therefore, the polymer dispersion of Comp. Ex. E does not have fast-set/instant tack or foam tear bonding. Therefore, one skilled in the art might expect that a waterborne contact adhesive polymer dispersion at less than pH 7.5 might not have fast-set/instant tack or foam tear bonding. Surprisingly, the waterborne contact adhesive polymer dispersions of Inv. Ex. 1-23 which comprise component (B) and component (II) do have fast-set/instant tack or foam tear bonding, with foam tear bonding in less than 15 min in some cases. The results also indicate that a formulation at less than pH 7.5 is advantageous to achieve the desirable properties of fast-set/instant tack and foam tear bonding for the contact adhesive polymer dispersion composition of the present invention.

The polymer dispersions of Comp. Ex. G and Comp. Ex. H are sprayable and formulated at less than pH 7.5 through stabilization with an acid surfactant salt with pKaH less than 2.6 (sodium dodecylbenzenesulfonate) and, in the case of Comp. Ex. G, copolymerized MAA units at greater than 0.5%. However, the polymer dispersions of Comp. Ex. G and Comp. Ex. H lack component (D); and therefore, the polymer dispersions of Comp. Ex. G and Comp. Ex. H do not form bonds, within 60 minutes, strong enough to resist failure of the adhesive bond before the bonded foam tears (foam tear bonding). In a similar way, polymer dispersions of Comp. Ex. I is sprayable and formulated at less than pH 7.5 but contains greater than 2% of a surfactant with pKaH less than 2.6. Therefore, the polymer dispersion of Comp. Ex. I does not have initial tack or form bonds, within 60 minutes, strong enough to resist failure of the adhesive bond before the bonded foam tears (foam tear bonding). Without being limited by theory, the lack of component (D), the presence of an acid surfactant salt with pKaH less than 2.6 at greater than 2%, or copolymerized acid greater than 0.5% is believed to impart too much stability to the polymer dispersions for the polymer dispersions to achieve the desirable properties of fast-set/instant tack and foam tear bonding.

In addition, the polymer dispersions of Comp. Ex. J and Comp. Ex. K are sprayable and formulated at less than pH 7.5, but the polymer of Comp. Ex. J has a calculated (meth)acrylic polymer Tg greater than −10° C., while the polymer of Comp. Ex. K has greater than 0.5% of polyethylenically unsaturated monomer. Therefore, the polymer dispersions of Comp. Ex. J and Comp. Ex. K do not have initial tack or form bonds, within 60 minutes, strong enough to resist failure of the adhesive bond before the bonded foam tears (foam tear bonding). Without being limited by theory, the meth(acrylic) polymer Tg greater than −10° C. or the presence of greater than 0.5% of polyethylenically unsaturated monomer is believed to make the polymers too hard or too pre-crosslinked for the polymer dispersions to achieve the desirable properties of fast-set/instant tack and foam tear bonding.

### OTHER EMBODIMENTS

In addition to the embodiments described above and those set forth in the Examples, many embodiments of specific combinations are within the scope of the present invention, some of which are described herein below.

Embodiment 1. A waterborne precursor polymer dispersion composition comprising the reaction product obtained by free-radical emulsion polymerization of a monomer mixture comprising: (A) at least one alkyl (meth)acrylate; and (B) at least one ethylenically unsaturated compound comprising: (Bi) at least one first functional group; wherein the at least one first functional group comprises at least one ethylenically unsaturated group; and (Bii) at least one second functional group; wherein the at least one second functional group comprises at least one functional group different than the ethylenically unsaturated group; wherein the second functional group is capable of reacting with a crosslinker component; and wherein the crosslinker component is not reactive with component (A) in free-radical polymerization; in the presence of: (C) an aqueous medium; and (D) at least one acid surfactant salt with pKaH from 2.6 to 7; wherein the molecule of the acid surfactant salt contains 10 or more carbon atoms; and wherein the composition includes further additives selected from the group consisting of a hydroxy-C2-C4 alkyl ester of a monoethylenically unsaturated C3-C8 monocarboxylic acid, a neutralizer, a plasticizer, and mixtures thereof.

Embodiment 2. The composition of any preceding or succeeding Embodiment, wherein the aqueous medium includes the at least one acid surfactant salt with conjugate acids pKa from 2.6 to 7 at a concentration of from 0.15 weight percent to 5 weight percent; wherein the monomer mixture includes the at least one alkyl (meth)acrylate at a concentration of from 55 weight percent to 99.75 weight percent; and wherein the monomer mixture includes the at least one ethylenically unsaturated compound having at least a first functional group and at least a second functional group at a concentration of from 0.25 weight percent to 10 weight percent.

Embodiment 3. A process for preparing a waterborne precursor polymer dispersion composition comprising polymerizing, by free-radical emulsion polymerization, a monomer mixture comprising: (A) at least one alkyl (meth)acrylate; and (B) at least one ethylenically unsaturated compound comprising: (Bi) at least one first functional group; wherein the at least one first functional group comprises at least one ethylenically unsaturated group; and (Bii) at least one second functional group; wherein the at least one second functional group comprises at least one functional group different than the ethylenically unsaturated group; wherein the second functional group is capable of reacting with a crosslinker component; and wherein the crosslinker component is not reactive with component (A) in free-radical polymerization; in the presence of: (C) an aqueous medium; and (D) at least one acid surfactant salt with pKaH from 2.6 to 7.

Embodiment 4. The process of any preceding or succeeding Embodiment, including further an initiator component to initiate free-radical emulsion polymerization.

Embodiment 5. A process for adhering at least two workpieces together to form a bonded article comprising the steps of: (a) providing a waterborne contact adhesive polymer dispersion composition of the present invention; (b) providing at least a first workpiece and at least a second workpiece to be bonded together; (c) applying the above waterborne contact adhesive polymer dispersion composition to at least a portion of the surface of the at least first workpiece or applying the waterborne contact adhesive polymer dispersion composition to at least a portion of the surface of the second workpiece, or applying the waterborne contact adhesive polymer dispersion composition to at least a portion of the surface of both the first and second workpieces to form at least one layer of the waterborne contact adhesive polymer dispersion composition on at least a portion of the surface of the first workpiece and/or the second workpiece; wherein the at least one layer of the waterborne contact adhesive polymer dispersion composition is disposed in between the first and second workpieces; (d) contacting the first and second workpieces together with the at least one layer of the waterborne contact adhesive polymer dispersion composition disposed in between the first and second workpieces; (e) drying, or allowing to dry, the at least one layer of the waterborne contact adhesive polymer dispersion composition disposed in between the first and second workpieces to form an adhesive bond bonding the first and second workpieces together to form a bonded article; and (f) pressing or applying pressure to, the first and second workpieces together with the at least one layer of the waterborne contact adhesive polymer dispersion composition disposed inbetween the first and second workpieces to bond the first and second workpieces together and form a bonded article.

Embodiment 6. The process of any preceding or succeeding Embodiment, wherein the bonded article is comprised of foam.

Embodiment 7. A bonded article comprising at least two substrates adhered together with the waterborne contact adhesive polymer dispersion composition of the present invention; wherein the bond strength of the bonded article is generally ≥10 kPa in one embodiment, from 10 kPa to 500 kPa in another embodiment, and from 500 kPa to 2,000 kPa in still another embodiment.

1. A waterborne precursor polymer dispersion composition comprising the reaction product obtained by free-radical emulsion polymerization of a monomer mixture comprising:
(A) at least one alkyl (meth)acrylate; and
(B) at least one ethylenically unsaturated compound comprising:
(Bi) at least one first functional groups, wherein the at least one first functional group comprises at least one ethylenically unsaturated group; and
(Bii) at least one second functional group, wherein the at least one second functional group comprises at least one functional group different than the ethylenically unsaturated groups wherein the second functional group is capable of reacting with a crosslinker component; and wherein the crosslinker component is not reactive with component (A) in free-radical polymerization, in the presence of:
(C) an aqueous medium; and
(D) at least one acid surfactant salt with pKaH from 2.6 to 7; wherein the molecule of the acid surfactant salt contains 10 or more carbon atoms.

2. The composition of claim 1, wherein the pH of the waterborne precursor polymer dispersion composition is less than 7.5.

3. The composition of claim 1, wherein the at least one second functional group, component (Bii), is selected from the group consisting of ketones, aldehydes, acetoacetate, and epoxy groups.

4. The composition of claim 1, wherein the at least one acid surfactant salt, component (D), is selected from the group consisting of alkali metal salts, ammonia salts, and tertiary amino salts of N-acyl amino carboxylic acids; lactylic esters of carboxylic acids; alkyl ether carboxylic acids; and mixtures thereof.

5. The composition of claim 1, wherein the aqueous medium includes the at least one acid surfactant salt with conjugate acids having a pKaH of from 2.6 to 7.

6. The composition of claim 1, wherein the glass transition temperature of the precursor polymer dispersion composition is from −80° C. to −10° C.

7. The composition of claim 1, id further c an initiator component to initiate free-radical emulsion polymerization.

8. A process for preparing a waterborne precursor polymer dispersion composition comprising:
polymerizing, by free-radical emulsion polymerization, a monomer mixture comprising:
(A) at least one alkyl (meth)acrylate; and
(B) at least one ethylenically unsaturated compound comprising:
(Bi) at least one first functional group; wherein the at least one first functional group comprises at least one ethylenically unsaturated group; and
(Bii) at least one second functional group; wherein the at least one second functional group comprises at least one functional group different than the ethylenically unsaturated group; wherein the second functional group is capable of reacting with a crosslinker component; and wherein the crosslinker component is not reactive with component (A) in free-radical polymerization; in the presence of
(C) an aqueous medium; and
(D) at least one acid surfactant salt with pKaH from 2.6 to 7.

9. A waterborne contact adhesive polymer dispersion composition comprising:
a mixture of,
(I) the waterborne precursor polymer dispersion composition of claim 1; and
(II) a crosslinker compound for crosslinking with the at least one second functional group component (Bii).

10. The composition of claim 9, wherein the pH of the waterborne contact adhesive polymer dispersion composition is less than 7.5.

11. The composition of claim 9, wherein the waterborne contact adhesive polymer dispersion composition is poly(chloroprene)-free and fast-setting.

12. A process for preparing a waterborne contact adhesive polymer dispersion composition comprising:
mixing
(I) the waterborne precursor polymer dispersion composition of claim 1; and
(II) at least one crosslinker compound for crosslinking with the at least one second functional group component (Bii).

13. A process of adhering two surfaces of a single first workpiece to form a bonded article comprising the steps of:
(a) providing the waterborne contact adhesive polymer dispersion composition of claim 9;
(b) providing at least a first workpiece to be bonded;
(c) applying the waterborne contact adhesive polymer dispersion composition of claim 9 to at least a portion of the surface of the at least first workpiece to form at least one layer of the waterborne contact adhesive polymer dispersion composition disposed on the surface of the first workpiece to be bonded to itself;
(d) folding the first workpiece such that the layer of the waterborne contact adhesive polymer dispersion composition is disposed in between two surfaces of the folded first workpiece;
(e) optionally, drying, or allowing to dry, the at least one layer of the waterborne contact adhesive polymer dispersion composition;
(f) contacting the two folded surfaces of the first workpiece together with the at least one layer of the waterborne contact adhesive polymer dispersion composition disposed in between the folded surfaces to bond the first workpiece to itself; and
(g) optionally, drying, or allowing to dry, the at least one layer of the waterborne contact adhesive polymer dispersion composition disposed in between the folded surfaces of the first workpiece to form an adhesive bond.

14. A process for adhering at least two workpieces together to form a bonded article comprising the steps of:
(a) providing a waterborne contact adhesive polymer dispersion composition of claim 9;
(b) providing at least a first workpiece and at least a second workpiece to be bonded together;
(c) applying the waterborne contact adhesive polymer dispersion composition of claim 9 to at least a portion of the surface of the at least first workpiece or applying the waterborne contact adhesive polymer dispersion composition to at least a portion of the surface of the second workpiece, or applying the waterborne contact adhesive polymer dispersion composition to at least a portion of the surface of both the first and second workpieces to form at least one layer of the waterborne contact adhesive polymer dispersion composition on at least a portion of the surface of the first workpiece and/or the second workpiece;
(d) contacting the first and second workpieces together with the at least one layer of the waterborne contact adhesive polymer dispersion composition disposed in between the first and second workpieces;
(e) optionally, drying, or allowing to dry, the at least one layer of the waterborne contact adhesive polymer dispersion composition disposed in between the first and second workpieces to form an adhesive bond bonding the first and second workpieces together to form a bonded article; and
(f) optionally, pressing or applying pressure to, the first and second workpieces together with the at least one layer of the waterborne contact adhesive polymer dispersion composition disposed in between the first and second workpieces to bond the first and second workpieces together and form a bonded article.

15. A bonded article comprising at least two substrates adhered together with the waterborne contact adhesive polymer dispersion composition of claim 10.
